(19) United States
(12) Patent Application Publication
(10) Pub. No.: US 2017/0168238 A1
(43) Pub. Date: Jun. 15, 2017

(54) WAVELENGTH DIVISION DEVICE, WAVELENGTH DIVISION MULTIPLEXING SYSTEM AND WAVELENGTH MULTIPLEXING SYSTEM

(71) Applicant: Electronics and Telecommunications Research Institute, Daejeon (KR)

(72) Inventors: Jaegyu PARK, Incheon (KR); Myungjoon KWACK, Gimpo (KR); Gyungock KIM, Daejeon (KR); Jiho JOO, Sejong (KR)

(21) Appl. No.: 15/347,679

(22) Filed: Nov. 9, 2016

(30) Foreign Application Priority Data
Dec. 10, 2015 (KR) 10-2015-0176196
Jun. 30, 2016 (KR) 10-2016-0082922

(51) Int. Cl. G02B 6/12; G02B 6/293; H04J 14/02

(52) U.S. Cl. CPC G02B 6/12016; H04J 14/02; G02B 6/12019; G02B 6/12021; G02B 6/12002; G02B 6/2938

(57) ABSTRACT

Provided is a wavelength division device. The wavelength division device includes input arrayed waveguides, an input circular grating coupler connected to one ends of the input arrayed waveguides and configured to refract first light having a plurality of wavelengths and output the refracted first light to each of the one ends of the input arrayed waveguides as plurality of second light, and an output star coupler connected to the other ends of the input arrayed waveguides and configured to receive the plurality of second light from the other ends of the input arrayed waveguides and output optical signals that are divided for each wavelength. The input circular grating coupler includes a plurality of circular gratings.

### CROSS-REFERENCE TO RELATED APPLICATIONS

This U.S. non-provisional patent application claims priority under 35 U.S.C. §119 of Korean Patent Application Nos. 10-2015-0176196, filed on Dec. 10, 2015, and 10-2016-0082922, filed on Jun. 30, 2016, the entire contents of which are hereby incorporated by reference.

### BACKGROUND

The present disclosure herein relates to a photonic device, and more particularly, to a wavelength division device using a circular grating coupler and an arrayed waveguide grating and a wavelength division multiplexing system and a wavelength multiplexing system, each of which includes the same.

In recent years, a photonic device for multiplexing/demultiplexing a signal in photonic communication fields and photonic integrated circuit (PIC) fields may include an arrayed waveguide grating (AWG), an echelle grating, a ring filter, or a mach-zehnder interferometer. Among these devices, the AWG may be a wavelength division multiplexer (WDM) that is most widely used. Particularly, the silicon-based AWG having a high refractive index between a core and a clade has a large device size and is capable of being mass-produced. Also, an individual device within the PIC gradually decreases in size due to the integration of the PIC, and efforts for minimizing a loss of optical power is proceeding.

### SUMMARY

The present disclosure provides a wavelength division device that has improved accuracy and is advantageous for high integration and a wavelength division multiplexing system.

The present disclosure also provides a wavelength multiplexing system in which a process of distributing an optical signal having multi-wavelengths is unified to reduce an optical loss.

An embodiment of the inventive concept provides a wavelength division device including input arrayed waveguides, an input circular grating coupler, and an output star coupler. The input circular grating coupler is connected to one ends of the input arrayed waveguides and refracts first light having a plurality of wavelengths to output the refracted first light to each of the one ends of the input arrayed waveguides as plurality of second light. The output star coupler is connected to the other ends of the input arrayed waveguides and receives the plurality of second light from the other ends of the input arrayed waveguides to output optical signals that are divided for each wavelength. Also, the input circular grating coupler includes a plurality of circular gratings.

In an embodiment of the inventive concept, a wavelength division multiplexing system includes a wavelength division device, a photonic component, and a wavelength coupling device. The wavelength division device received first multi-wavelength light having a plurality of wavelengths to output optical signals that are divided for each wavelength. The photonic component receives the optical signals that are divided for each wavelength to output optically processed optical signals. The wavelength coupling device receives the optically processed optical signals to output second multi-wavelength light having a plurality of wavelengths. The wavelength division device includes: input arrayed waveguides; an input circular grating coupler connected to one ends of the input arrayed waveguides and configured to refract first light having a plurality of wavelengths and output the refracted first light to each of the one ends of the input arrayed waveguides as plurality of second light; and an output star coupler connected to the other ends of the input arrayed waveguides and configured to receive the plurality of second light from the other ends of the input arrayed waveguides and output optical signals that are divided for each wavelength. The input circular grating coupler includes a plurality of circular gratings.

In an embodiment of the inventive concept, a wavelength multiplexing system includes an input waveguide structure and a layer structure. The input waveguide structure includes a plurality of optical channels and optically couples first optical signals received from the plurality of optical channels to each other to output a second optical signal. Also, the layer structure receives the second optical signal, is three-dimensionally stacked, includes a plurality of layers, and each of the plurality of layers includes a wavelength division device, and the wavelength division device includes an input circular grating coupler having wavelength responsibility according to each of the plurality of layers and refracts an optical signal, which is optically and selectively coupled to the circular grating coupler according to the wavelength responsibility, of the second optical signal to output a plurality of third optical signals.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a plan view of an arrayed waveguide grating including a star coupler;

FIG. 2 is a plan view of a wavelength division device according to an embodiment of the inventive concept;

FIG. 3 is a view illustrating an operation example of the wavelength division device according to an embodiment of the inventive concept;

FIGS. 4 and 5 are cross-sectional views of an arrayed waveguide;

FIG. 6 is a plan view of an input circular grating coupler according to an embodiment of the inventive concept;

FIG. 7 is a plan view of an input circular grating coupler according to another embodiment of the inventive concept;

FIG. 8 is a plan view of a wavelength division multiplexing system according to an embodiment of the inventive concept;

FIG. 9 is a plan view of a wavelength division multiplexing system according to another embodiment of the inventive concept;

FIGS. 10 to 13 are plan views of an output grating coupler of a wavelength coupling device according to an embodiment of the inventive concept;

FIGS. 14 to 17 are views of an output grating coupler of the wavelength coupling device of FIG. 9 according to an embodiment of the inventive concept;

FIGS. 18 and 19 are views illustrating a case in which the wavelength division devices are vertically stacked according to an embodiment of the inventive concept;

FIG. 20 is a view illustrating a case in which the wavelength division device and the wavelength division multiplexing systems are vertically stacked according to an embodiment of the inventive concept;

FIG. 21 is a side view illustrating one example in which the input circular grating coupler is connected to one side of an input arrayed waveguide structure;

FIG. 22 is a view illustrating a state in which light is coupled in the side view illustrating the one example in which the input circular grating coupler is connected to the one side of the input arrayed waveguide structure;

FIG. 23 is a side view illustrating another example in which the input circular grating coupler is connected to the one side of the input arrayed waveguide structure.

FIG. 24 is a view illustrating a state in which light is coupled in the side view illustrating another example in which the input circular grating coupler is connected to the one side of the input arrayed waveguide structure;

FIG. 25A is a cross-sectional view illustrating an example of a first region of the input array waveguide structure;

FIG. 25B is a cross-sectional view illustrating an example of a second region of the input array waveguide structure;

FIG. 26 is a view of a wavelength multiplexing system having a layer structure according to an embodiment of the inventive concept;

FIG. 27 is a detailed view of the wavelength multiplexing system having the layer structure of FIG. 26 according to an embodiment of the inventive concept;

FIG. 28 is a view illustrating characteristics related to wavelength responsibility of a plurality of circular grating couplers;

FIG. 29 is a view of a wavelength division device that is applicable to an embodiment of the inventive concept;

FIG. 30 is a view of a wavelength division device that is applicable to an embodiment of the inventive concept;

FIG. 31 is a detailed view illustrating a structure of the wavelength division device of FIG. 30 according to an embodiment of the inventive concept;

FIG. 32 is a detailed view illustrating a structure of the wavelength division device of FIG. 31 according to an embodiment of the inventive concept;

FIG. 33 is a cross-sectional view of the wavelength division device of FIG. 31;

FIG. 34 is a cross-sectional view of the wavelength division device of FIG. 31;

FIG. 35 is a cross-sectional view of the wavelength division device of FIG. 32;

FIGS. 36A and 36B are views illustrating a structure of a reflection part of an input waveguide structure of the wavelength division system according to an embodiment of the inventive concept;

FIGS. 37A and 37B are views illustrating a structure of a reflection part of an input waveguide structure of the wavelength division system according to another embodiment of the inventive concept; and

FIG. 38 is a view illustrating one of application examples of the inventive concept.

### DETAILED DESCRIPTION

The above-described characteristics and the following detailed description are merely examples for helping the understanding of the inventive concept. That is, the inventive concept may be embodied in different forms and should not be constructed as limited to the embodiments set forth herein. The following embodiments are merely examples for completely disclosing the inventive concept and for delivering the inventive concept to those skilled in the art that the inventive concept belongs. Therefore, in the case where there are multiple methods for implementing the elements of the inventive concept, the inventive concept may be implemented with any of the methods or an equivalent thereof.

When it is mentioned that a certain configuration includes a specific element or a certain process includes a specific step, another element or another step may be further included. That is, the terms used herein are not for limiting the concept of the inventive concept, but for describing a specific embodiment. Furthermore, the embodiments described herein include complementary embodiments thereof.

The terms used herein have meanings that are generally understood by those skilled in the art. The commonly used terms should be consistently interpreted according to the context of the specification. Furthermore, the terms used herein should not be interpreted as overly ideal or formal meanings, unless the meanings of the terms are clearly defined. Hereinafter, the embodiments of the inventive concept will be described with reference to the accompanying drawings.

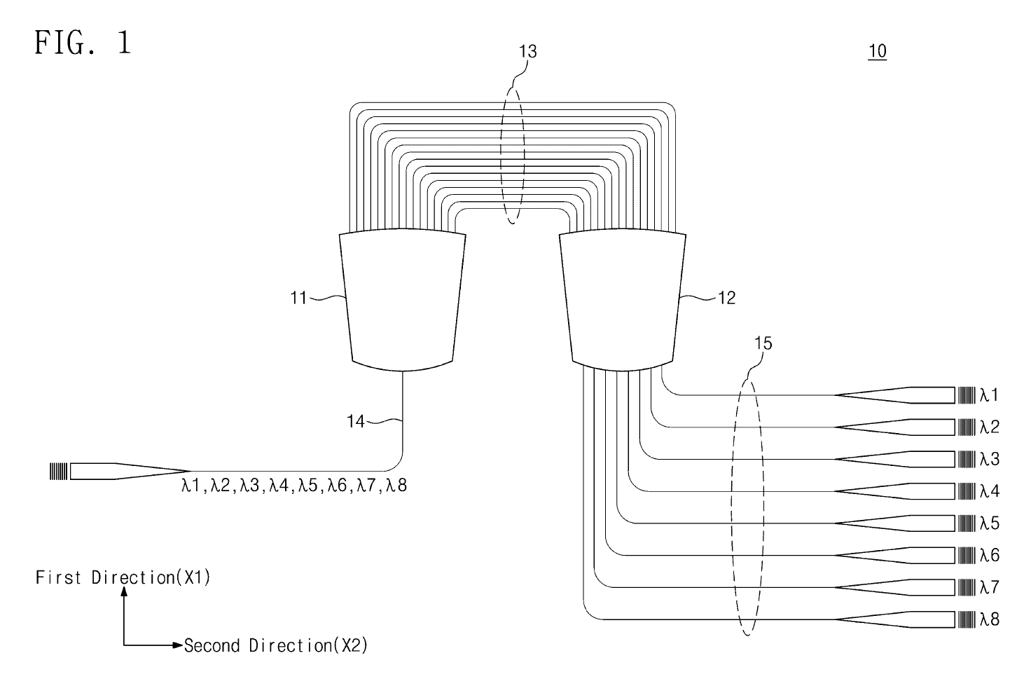

FIG. 1 is a plan view of an arrayed waveguide grating 10 including a star coupler.

Referring to FIG. 1, the arrayed waveguide grating 10 may include a first star coupler 11, a second star coupler 12, an arrayed waveguide structure 13, an input waveguide 14, and output waveguides 15.

The arrayed waveguide structure 13 may be connected to one side of the first star coupler 11, and the input waveguide 14 may be connected to the other side of the first star coupler 11. The first star coupler 11 and the output star coupler 12 may be disposed adjacent to each other. The first star coupler 11 may provide light to the arrayed waveguide structure 13. In this case, intensities of optical signals outputted from the first star coupler 11 to the arrayed waveguide structure 13 may depend on Gaussian distribution.

The arrayed waveguide structure 13 may be connected to one side of the second star coupler 12, and the output waveguides 15 may be connected to the other side of the second star coupler 12.

The second star coupler 12 may output optical signals that are divided for each wavelength to the output waveguides 15 in case of a demultiplexing operation. For example, in case of the demultiplexing operation, the optical signals having several wavelengths may be incident into the input waveguide 14 through a single optical fiber. Then, the optical signals that are divided for each wavelength by the second star coupler 12 may be outputted through a plurality of optical fibers respectively connected to the output waveguides 15.

On the other hand, the second star coupler 12 may output the optical signals having the several wavelengths through the input waveguide 14 in case of a multiplexing operation. For example, in case of the multiplexing operation, the optical signals that are divided for each wavelength may be incident into the output waveguides 15 through the plurality of optical fibers, respectively. Then, the optical signals having the several wavelengths coupled by the second star coupler 12 may be outputted through the input waveguide 14.

The arrayed waveguide structure 13 may include a plurality of arrayed waveguides. The first star coupler 11 may be disposed on one side of the arrayed waveguide structure 13, and the second star coupler 12 may be disposed on the other side of the arrayed waveguide structure 13. The arrayed waveguides may be connected between the first star coupler 11 and the second star coupler 12.

Particularly, the plurality of arrayed waveguides of the arrayed waveguide structure 13 connected to the one side of the first star coupler 11 may extend in a first direction X1. Then, the arrayed waveguides extending in the first direction X1 may extend in a state of being bent in a second direction X2. Alternatively, the arrayed waveguides extending in the first direction X1 may extend while being bent in the second direction X2. Then, the plurality of arrayed waveguides that extend in the state of being bent in the second direction X2 or extend while being bent in the second direction X2 may extend in a direction opposite to the first direction X1 and connected to the other side of the second star coupler 12.

The arrayed waveguides of the arrayed waveguide structure 13 may have a predetermined length difference therebetween. Also, the arrayed waveguides of the arrayed waveguide structure 13 may be disposed in parallel to each other. Also, the arrayed waveguide structure 13 may function as a diffraction grating. Thus, the optical signals outputted from the arrayed waveguides may be focused to positions different from each other according to the wavelengths.

The input waveguide 14 may provide light to the first star coupler 11 or receive light from the first star coupler 11. For example, in case of the demultiplexing operation, the input waveguide 14 may transmit optical signals having several wavelengths to the input star coupler 11. On the other hand, in case of the multiplexing operation, the input waveguide 14 may transmit the optical signal having the several wavelengths, which are outputted from the input star coupler 11, to an external device (not shown).

The output waveguides 15 may provide light to the second star coupler 12 or receive light from the second star coupler 12. For example, in case of the demultiplexing operation, the output waveguides 15 may transmit the optical signals that are divided for each wavelength to the external device (not shown). On the other hand, in case of the multiplexing operation, the output waveguides 15 may transmit the optical signals that are divided for each the wavelength to the second star coupler 12.

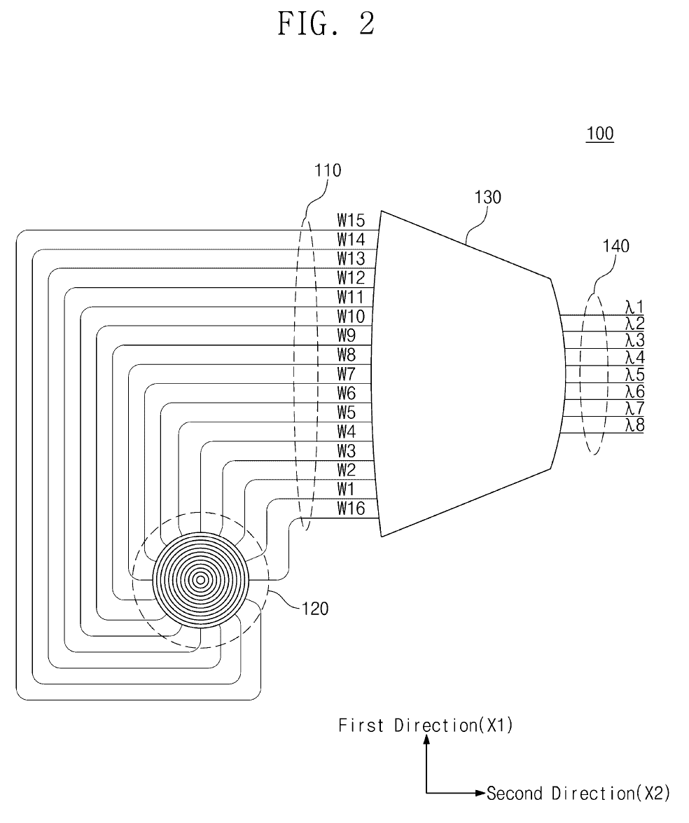

FIG. 2 is a plan view of a wavelength division device 100 according to an embodiment of the inventive concept.

Referring to FIG. 2, the wavelength division device 100 may include an input arrayed waveguide structure 110, an input circular grating coupler 120, an output star coupler 130, and output arrayed waveguides 140.

The input arrayed waveguide structure 110 may include a plurality of input arrayed waveguides. For example, the input arrayed waveguide structure 110 may include first to sixteenth input arrayed waveguides W1 to W16. The input arrayed waveguide structure 110 has one side connected to the input circular grating coupler 120 and the other side connected to the output star coupler 130.

Particularly, the first and sixteenth input arrayed waveguides W1 to W16 of the input arrayed waveguide structure 110 may extend in a direction perpendicular to a tangent of the outermost circular grating of the input circular grating coupler 120.

For example, each of the first to seventh input arrayed waveguides W1 to W7, which extend in a direction perpendicular to the tangential direction of the outermost circular grating, may extend in the state of being bent or curved in the first direction X1. Then, each of the first to seventh input arrayed waveguides W1 to W7 may extend in the state of being bent or curved in the second direction X2. Then, each of the first to seventh input arrayed waveguides W1 to W7 may be connected to the output star coupler 130.

For example, each of the eighth to eleventh input arrayed waveguides W8 to W11, which extend in the direction perpendicular to the tangential direction of the outermost circular grating, may extend in a state of being bent or curved in the direction opposite to the second direction X2. Then, each of the eighth to eleventh input waveguides W8 to W11 may extend in a state of being bent or curved in the first direction X1. Then, each of the eighth to eleventh input waveguides W8 to W11 may extend in a state of being bent or curved in the second direction X2. Then, each of the eighth to eleventh input arrayed waveguides W1 to W7 may be connected to the output star coupler 130.

For example, each of the twelfth to fifteenth input arrayed waveguides W12 to W15, which extend in the direction perpendicular to the tangential direction of the outermost circular grating, may extend in the state of being bent or curved in the direction opposite to the first direction X1. Then, each of the twelfth to fifteenth input arrayed waveguides W12 to W15 may extend in the state of being bent or curved in the direction opposite to the second direction X2. Then, each of the twelfth to fifteenth input waveguides W12 to W15 may extend in the state of being bent or curved in the first direction X1. Then, each of the twelfth to fifteenth input waveguides W12 to W15 may extend in the state of being bent or curved in the second direction X1. Then, each of the twelfth to fifteenth input arrayed waveguides W12 to W15 may be connected to the output star coupler 130.

For example, the sixteenth input arrayed waveguide W16, which extends in the direction perpendicular to the tangential direction of the outermost circular grating, may extend in a state of being bent or curved in the second direction X2. Then, the sixteenth input arrayed waveguide W16 may extend in the state of being bent or curved in the first direction X1. Then, the sixteenth input arrayed waveguide W16 may extend in a state of being bent or curved in the second direction X2. Then, the sixteenth input arrayed waveguide W16 may be connected to the output star coupler 130.

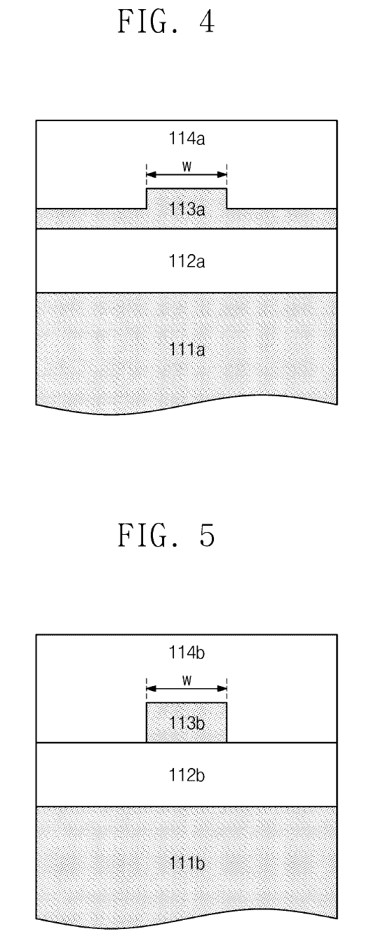

The arrayed waveguides of the input arrayed waveguide structure 110 may have a predetermined length difference therebetween. Also, the arrayed waveguides of the input arrayed waveguide structure 110 may be disposed in parallel to each other. Also, the input arrayed waveguide structure 110 may function as a diffraction grating. An inner structure of the input arrayed waveguide structure 110 will be described in more detail with reference to FIGS. 4 and 5.

The input circular grating coupler 120 may be connected to one side of the input arrayed waveguide structure 110, and the inside of the input circular grating coupler 120 may include a plurality of circular gratings. For example, the input circular grating coupler 120 may have a shape with radii that have the same center and gradually increase at a predetermined distance. Thus, the input circular grating coupler 120 may diffract first light having a plurality of wavelengths to output a plurality of second light. For example, the first light may be diffracted to a plane that is perpendicular to an incident path. For example, the plurality of second light may be a plurality of optical signals having intensities in which the intensity of the first light is equally distributed. Here, the plurality of second light may have a plurality of wavelengths. For example, in case of FIG. 2, the plurality of second light may have first to eight wavelengths λ1 to λ8.

The output star coupler 130 may receive the plurality of second light through the input arrayed waveguide structure 110. Here, the output star coupler 130 may demultiplex the plurality of received second light for each wavelength to output the demultiplexed light to the output waveguides 140. For example, in case of FIG. 2, the output star coupler 130 may output optical signals having the wavelengths λ1 to λ8 that are demultiplexed for each wavelength through the output waveguides 140.

The output arrayed waveguides 140 may be connected to the other side of the output star coupler 130. Also, each of the output arrayed waveguides 140 may output the optical signals having the wavelengths λ1 to λ8 that are demultiplexed for each wavelength from the output star coupler 130 to an external device (not shown). An inner structure of each of the output arrayed waveguides 140 will be described in more detail with reference to FIGS. 4 and 5.

As described above, the input star coupler 11 of FIG. 1 may output optical signal according to Gaussian distribution. On the other hand, the input circular grating coupler 120 of FIG. 2 may output a plurality of optical signals having equally distributed intensities. Thus, the wavelength division device 100 including the input circular grating coupler 120 of FIG. 2 may have more improved uniformity (accuracy) of the signal intensities that are multiplexed in wavelength.

Furthermore, the input circular grating coupler 120 of FIG. 2 may have a structure that is advantageous for high integration because of being substituted for the input star coupler 11 and the input waveguide 14 of FIG. 1.

The plurality of input arrayed waveguides of the input arrayed waveguide structure 110, the plurality of circular gratings of the input circular grating coupler 120, and the output arrayed waveguides 140 are not limited to the structure illustrated in FIG. 2. That is, it is understood that embodiments to which various changes are made without departing from the spirit and scope of the inventive concept are possible.

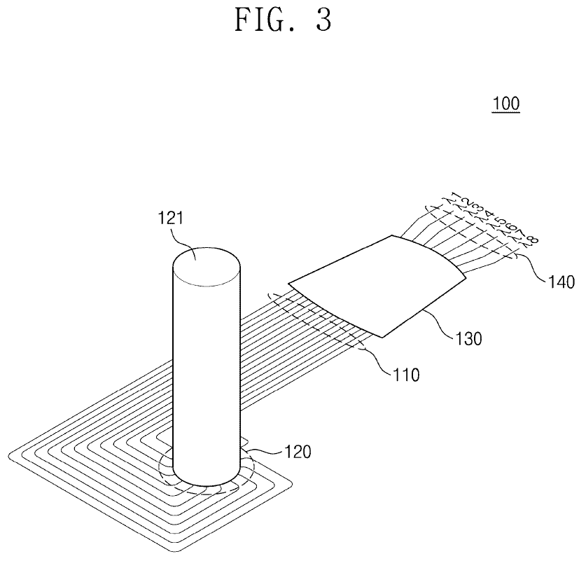

FIG. 3 is a view illustrating an operation example of the wavelength division device 100 according to an embodiment of the inventive concept. However, detailed descriptions with respect to the same component as that of FIG. 2 will be omitted in FIG. 3.

An optical fiber 121 may apply the first light having the plurality of wavelengths to the input circular grating coupler 120. The optical fiber 121 may be vertically connected to the input circular grating coupler 120. Also, the optical fiber 121 may transmit light that is multiplexed or concentrated in the other layer to the input circular grating coupler 120.

Also, each of the output arrayed waveguides 140 may output the optical signals having the wavelengths λ1 to λ8 that are demultiplexed for each wavelength from the output star coupler 130 to an external device (not shown). For example, the external device may be a photonic device, for example, a polarization device, a splitter, or a modulator.

For another example, the output arrayed waveguides 140 may be connected to a plurality of optical fibers (not shown), respectively. The optical signals having the wavelengths λ1 to λ8 that are demultiplexed for each wavelength may be transmitted to other layers, which are vertically stacked, through the plurality of optical fibers (not shown).

FIGS. 4 and 5 are cross-sectional views of the arrayed waveguide. The cross-section of the arrayed waveguide of FIGS. 4 and 5 may be a cross-section of one input arrayed waveguide of the plurality of input arrayed waveguides constituting the input arrayed waveguide structure 110 of FIG. 2. Also, the cross-section of the arrayed waveguide of FIGS. 4 and 5 may be a cross-section of one output arrayed waveguide of the output arrayed waveguides 140. For brief description, it is assumed that the cross-section of the arrayed waveguide of FIGS. 4 and 5 is one input arrayed waveguide of the plurality of input arrayed waveguides constituting the input arrayed waveguide structure 110 of FIG. 2.

Referring to FIG. 4, a structure of a rib-type arrayed waveguide is illustrated. The rib-type arrayed waveguide may include a substrate 111a, a lower clade 112a, a propagation layer 113a, and an upper clade 114a.

The substrate 111a may be single crystal silicon (Si). The lower clade 112a may be silicon oxide (SiO₂).

The propagation layer 113a may be single crystal silicon (Si). The propagation layer 113a may correspond to a portion through which light applied from the optical fiber passes. The propagation layer 113a may have a width W of about 600 nm. The propagation layer 113a may have a cross-section having a ‘T’ shape that is overturned up and down. The lower clade 112a and the upper clade 114a are disposed on top and bottom surfaces of the propagation layer 113a, respectively. In this case, the propagation layer 113a may have a refractive index of about 3.47, and each of the lower clade 112a and the upper clade 114a may have a refractive index of about 1.46 to about 1.51. That is, the propagation layer 113a may have a refractive index greater than that of each of the lower clade 112a and the upper clade 114a. Thus, light within the propagation layer 113a may be transmitted through total reflection. The upper clade 114a may be silicon oxide (SiO₂) and have a ‘U’ shape that is overturned up and down.

The rib-type arrayed waveguide may have an internal less than that of a channel-type arrayed waveguide that will be described later. Also, light passing through the rib-type arrayed waveguide may relatively less affected by a change of a sidewall of the waveguide when compared to the channel-type arrayed waveguide.

Referring to FIG. 5, a structure of the channel-type arrayed waveguide is illustrated. The channel-type arrayed waveguide may include a substrate 111b, a lower clade 112b, a propagation layer 113b, and an upper clade 114b.

The substrate 111b may be single crystal silicon (Si). The lower clade 112b may be silicon oxide (SiO₂).

The propagation layer 113b may be single crystal silicon (Si). The propagation layer 113b may correspond to a portion through which light applied from the optical fiber passes. The propagation layer 113b may have a width W of about 400 nm. The propagation layer 113a may have a rectangular cross-section. The lower clade 112b and the upper clade 114b are disposed on top and bottom surfaces of the propagation layer 113b, respectively. In this case, the propagation layer 113b may have a refractive index of about 3.47, and each of the lower clade 112b and the upper clade 114b may have a refractive index of about 1.46 to about 1.51. That is, the propagation layer 113b may have a refractive index greater than that of each of the lower clade 112b and the upper clade 114b. Thus, light within the propagation layer 113b may be transmitted through total reflection. The upper clade 114b may be silicon oxide (SiO₂) and have a ‘U’ shape that is overturned up and down.

The channel-type arrayed waveguide may have a radius curvature less than that of the rib-type arrayed waveguide.

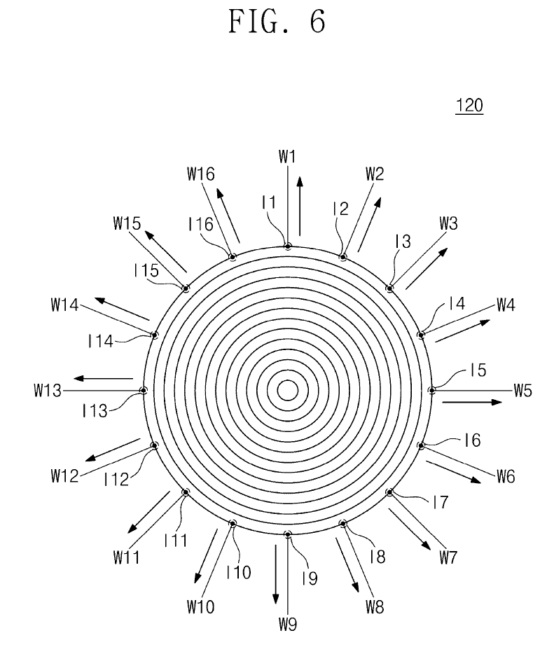

FIG. 6 is a plan view of the input circular grating coupler according to an embodiment of the inventive concept.

Referring to FIGS. 2 and 6, the input circular grating coupler 120 may include a plurality of circular gratings. For example, the input circular grating coupler 120 may have a shape with radii that have the same center and gradually increase at a predetermined distance. The input circular grating coupler 120 may diffract first light having a plurality of wavelengths, which is received through the optical fiber (not shown), to output a plurality of second light. For example, the first light may be diffracted to a plane that is perpendicular to an incident path. For example, the plurality of second light may be a plurality of optical signals having intensities in which the intensity of the first light is equally distributed. Here, the plurality of second light may have a plurality of wavelengths.

The outermost circular grating of the input circular grating coupler 120 may have at least two terminals. For example, in case of FIG. 6, the outermost circular grating of the input circular grating coupler 120 may include first to sixteenth terminals I1 to I16.

Each of the terminals of the outermost circular grating may be connected to one side of each of the input arrayed waveguides 110. For example, in case of FIG. 6, the first to sixteenth terminals I1 to I16 may be connected to the first to sixteenth waveguides W1 to W16, respectively.

Also, the plurality of second light having the intensities equally distributed through the input arrayed waveguides 110 connected to the outermost circular grating may be outputted.

The plurality of second light outputted from the input circular grating coupler 120 according to an embodiment of the inventive concept may have uniform intensity. Thus, errors that may occur in an optical processing process of a photonic component that will be described later may be reduced to improve the uniformity of the wavelength division device 100. Furthermore, the loss that may occur in the optical coupling process in which the terminals of the outermost circular grating of the input circular grating coupler 120 are provided in plurality to couple the optical fiber (not shown) to the input circular grating coupler 120 may be minimized. Thus, the loss that may occur in the optical coupling process may be reduced to more improve the accuracy of the wavelength division device 100.

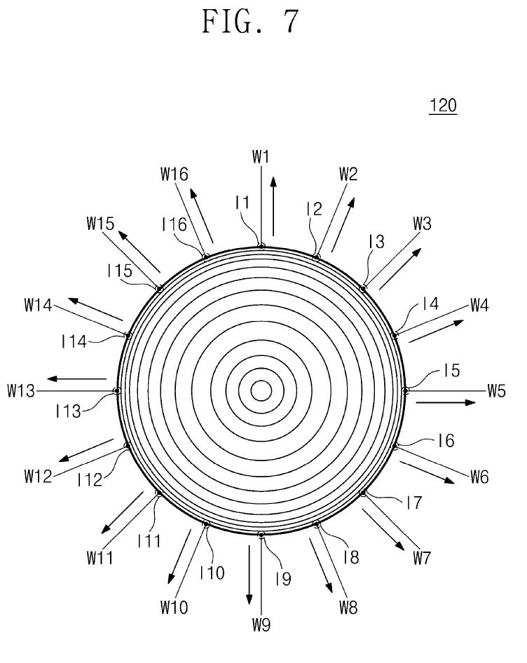

FIG. 7 is a plan view of an input circular grating coupler according to another embodiment of the inventive concept.

Referring to FIGS. 2 and 7, the input circular grating coupler 120 may include a plurality of circular gratings. For example, the plurality of circular gratings may have a shape with radii that have the same center and gradually increase at a gradually decreasing distance.

The input circular grating coupler 120 is not limited to the structure of FIGS. 6 and 7. That is, it is understood that embodiments to which various changes are made without departing from the spirit and scope of the inventive concept are possible.

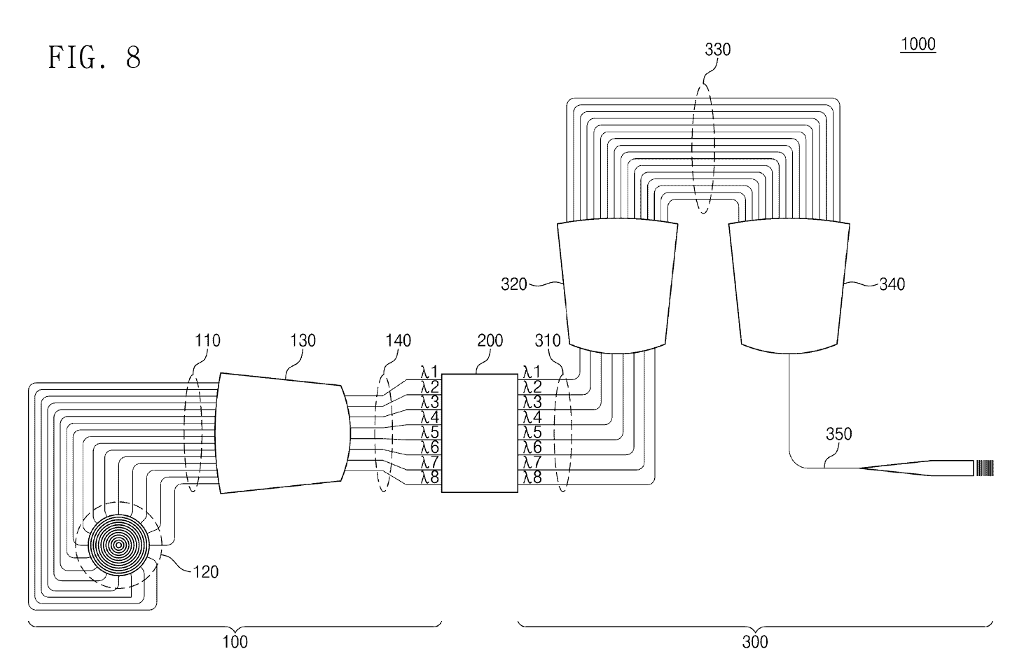

FIG. 8 is a plan view of a wavelength division multiplexing system 1000 according to an embodiment of the inventive concept.

Referring to FIG. 8, the wavelength division multiplexing system 1000 may include a wavelength division device (hereinafter, referred to as a demux) 100, photonic components, and a wavelength coupling device (hereinafter, referred to as a mux) 300.

The demux 100 may output optical signals that are divided for each wavelength on the basis of first light having a plurality of wavelengths received through an input circular grating coupler 120. For example, first to eighth optical signals λ1 to λ8 that are divided for each wavelength in the demux 100 may be transmitted to the mux 300 after being optically processed in the photonic components 200. For another example, the first to eighth optical signals λ1 to λ8 that are divided for each wavelength in the demux 100 may be transmitted to the mux 300 without passing through the photonic components 200. Since the demux 100 of FIG. 8 has the same structure and function as those of the wavelength division device of FIGS. 2 to 7, its detailed description will be omitted.

The photonic components 200 may receive the optical signals that are divided for each wavelength to output the optical signals that are optically processed. For example, the photonic components 200 may receive the first to eighth optical signals λ1 to λ8 that are divided for each wavelength to output optical signals λ1′ to λ8′ that are optically processed. For example, each of the photonic components 200 may be a polarization device, a splitter, or a modulator. The mux 300 may receive the optical signals that are divided for each wavelength or the optical signal that are optically processed. Also, the mux 300 may include output arrayed waveguides 310, an input star coupler 320, an output arrayed waveguide structure 330, an output star coupler 340, and an output waveguide 350. The mux 300 may perform the demultiplexing of FIG. 1. Thus, the mux 300 may output demultiplexed optical signals.

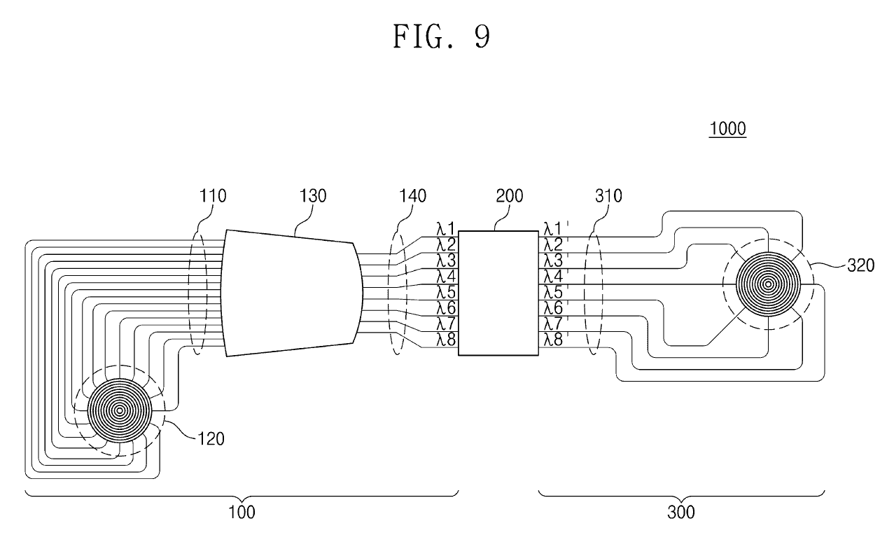

FIG. 9 is a plan view of a wavelength division multiplexing system 1000 according to another embodiment of the inventive concept.

Referring to FIG. 9, the wavelength division multiplexing system 1000 may include a wavelength division device (hereinafter, referred to as a demux) 100, photonic components, and a wavelength coupling device (hereinafter, referred to as a mux) 300.

The demux 100 may include an input arrayed waveguide structure 110, an input circular grating coupler 120, an output star coupler 130, and output arrayed waveguides 140. The demux 100 may output optical signals in which first multi-wavelength light having a plurality of wavelengths, which is received through the input circular grating coupler 120, is divided for each wavelength.

The input circular grating coupler 120 of the demux 100 may be connected to one side of the input arrayed waveguide structure 110, and the inside of the input circular grating coupler 120 may include a plurality of first circular gratings. For example, the plurality of first circular gratings may have a shape with radii that have the same center and gradually increase at a predetermined distance. Due to the above-described structure, the input circular grating coupler 120 may receive the first multi-wavelength light having the plurality of wavelengths to output a plurality of second light having equally distributed intensities. Here, the plurality of second light may have a plurality of wavelengths.

For example, the optical signals that are divided for each wavelength in the demux 100 may be transmitted to the mux 300 after being optically processed in the photonic components 200. For another example, the optical signals that are divided for each wavelength in the demux 100 may be transmitted to the mux 300 without passing through the photonic components 200. Since the demux 100 of FIG. 9 has the same structure and function as those of the wavelength division device of FIGS. 2 to 7, its detailed description will be omitted.

The photonic components 200 may receive the optical signals that are divided for each wavelength to output the optical signals that are optically processed. For example, the photonic components 200 may receive the first to eighth optical signals λ1 to λ8 that are divided for each wavelength to output optical signals λ1′ to λ8′ that are optically processed. For example, each of the photonic components 200 may be a polarization device, a splitter, or a modulator.

The demux 300 may include output arrayed waveguides 310 and an output grating coupler 320. The mux 300 may receive the optical signals that are divided for each wavelength or the optical signal that are optically processed.

For example, the mux 300 may receive the optical signals λ1 to λ8 that are divided for each wavelength or the optical signal λ1′ to λ8′ that are optically processed.

The output arrayed waveguides 310 may transmit the optical signals λ1′ to λ8′ that are optically processed to the output grating coupler 320. Each of the output arrayed waveguides may have one side connected to each of the photonic components 200 and the other side connected to the output circular grating coupler 320. The output arrayed waveguides 310 may have lengths different from each other. For example, the output arrayed waveguides 310 may be connected between the photonic components 200 and the output circular grating coupler 320. The output arrayed waveguides 310 may be curved. For example, each of the output arrayed waveguides 310 may be curved in a “U” shape. A length difference between the output arrayed waveguides 310 may occur.

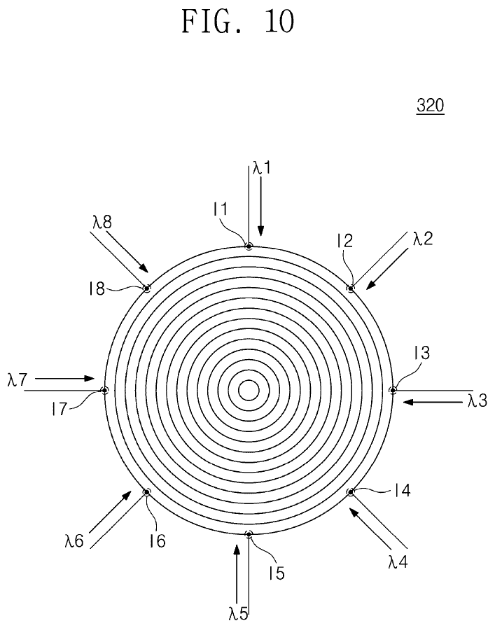

The output circular grating coupler 320 may multiplex the optical signals λ1 to λ8 that are divided for each wavelength or the optical signal λ1′ to λ8′ that are optically processed to output second multi-wavelength light having a plurality of wavelengths. For example, the output grating coupler 320 may include a plurality of second circular gratings. For example, the outermost circular grating of the output grating coupler 320 may include as many terminals as the number of optical signals that are divided for each wavelength. The optical signals λ1 to λ8 that are divided for each wavelength or the optical signal λ1′ to λ8′ that are optically processed may be transmitted to the output circular grating coupler 320 through the terminals of the outermost circular grating. A structure each of the plurality of second circular gratings will be described in more detail with reference to FIGS. 10 to 13.

FIGS. 10 to 13 are views of the output circular grating coupler 320 of the mux 300 of FIG. 9 according to an embodiment of the inventive concept.

Referring to FIGS. 9 and 10, the output circular grating coupler 320 of the mux 300 of FIG. 9 may include the plurality of second circular gratings. For example, the plurality of second circular gratings may have a shape with radii that have the same center and gradually increase at a predetermined distance. Also, the outermost circular grating 321a of the output circular grating coupler 320 may include as many terminals as the number of optical signals that are divided for each wavelength. For example, as illustrated in FIG. 10, when the optical signals λ1 to λ8 that are divided for each wavelength are applied to the output circular grating coupler 320, the outermost circular grating 321a may include first to eighth terminals I1 to I8.

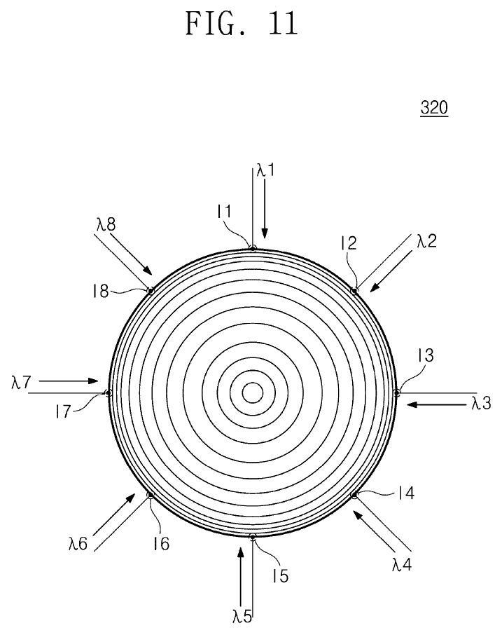

Referring to FIGS. 9 and 11, the output circular grating coupler 320 of the mux 300 of FIG. 9 may include the plurality of second circular gratings. For example, the plurality of second circular gratings may have a shape with radii that have the same center and gradually increase at a gradually decreasing distance.

Also, the outermost circular grating 321b of the output circular grating coupler 320 may include as many terminals as the number of optical signals that are divided for each wavelength. For example, as illustrated in FIG. 11, when the optical signals λ1 to λ8 that are divided for each wavelength are applied to the output circular grating coupler 320, the outermost circular grating 321b may include first to eighth terminals I1 to I8.

The outermost circular grating 321b of the output circular grating coupler 320 may multiplex the largest amount of optical signals of the optical signals that are divided for each wavelength to output second multi-wavelength light. Then, as the optical signals λ1 to λ8 that are divided for each wavelength are transmitted to a center of the output circular grating coupler 320, the amount of optical signals λ1 to λ8 that are divided for each wavelength, which are multiplexed to output the second multi-wavelength light may be reduced. As illustrated in FIG. 11, since a chirped circular gating structure having radii that gradually increase at a gradually decreasing distance with respect to the center of the output grating coupler 320, the optical signals that are divided for each wavelength may be efficiently multiplexed to output the second multi-wavelength light.

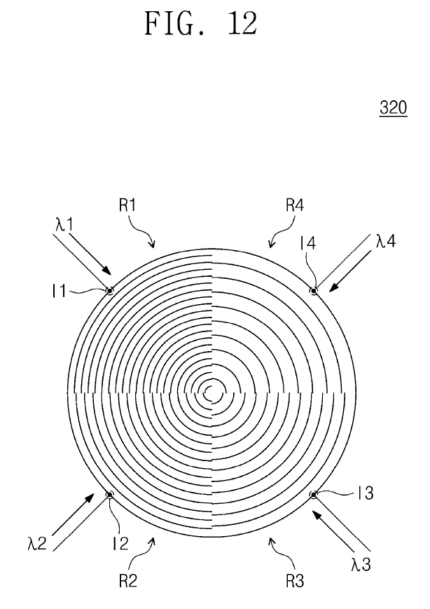

Referring to FIGS. 9 and 12, the output circular grating coupler 320 of the mux 300 of FIG. 9 may include first to fourth regions R1 to R4.

The first to fourth regions R1 to R4 may include first to fourth terminals I1 to I4, respectively. Also, the first to fourth terminals I1 to I4 may receive the optical signals having wavelengths λ1 to λ8 that are demultiplexed for each wavelength, respectively. Particularly, the output circular grating coupler 320 may have a circular shape, and spaces within the circular shape may be divided into the first to fourth regions R1 to R4 corresponding to the optical signals having the wavelengths λ1 to λ4 that are demultiplexed for each wavelength. Also, the first to fourth regions R1 to R4 may include gratings having arc shapes with radii that gradually increase with respect to the same center.

Thus, the output circular grating coupler 320 of FIG. 12 may more efficiently multiplex the optical signals having the wavelengths λ1 to λ4 that are demultiplexed for each wavelength to output the second multi-wavelength light when compared to the output circular grating coupler 320 of FIG. 10.

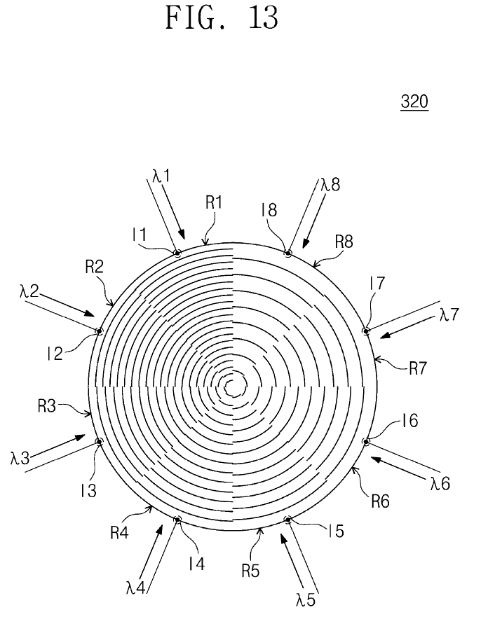

Referring to FIGS. 9 and 13, the output circular grating coupler 320 of the mux 300 of FIG. 9 may include first to eighth regions R1 to R8.

The first to eighth regions R1 to R8 may include first to eighth terminals I1 to I8, respectively. Also, the first to eighth terminals I1 to I8 may receive the optical signals having wavelengths λ1 to λ8 that are demultiplexed for each wavelength, respectively. Particularly, the output circular grating coupler 320 may have a circular shape, and spaces within the circular shape may be divided into the first to eighth regions R1 to R8 corresponding to the optical signals having the wavelengths λ1 to λ8 that are demultiplexed for each wavelength. Also, the first to eighth regions R1 to R8 may include gratings having arc shapes with radii that gradually increase with respect to the same center.

Thus, the output circular grating coupler 320 of FIG. 13 may more efficiently multiplex the optical signals having the wavelengths λ1 to λ8 that are demultiplexed for each wavelength to output the second multi-wavelength light when compared to the output circular grating coupler 320 of FIG. 11.

The output circular grating coupler 320 of the mux 300 is not limited to the structures of FIGS. 10 to 13. That is, it is understood that embodiments to which various changes are made without departing from the spirit and scope of the inventive concept are possible.

FIGS. 14 to 17 are views of an output grating coupler 320 of the mux 300 of FIG. 9 according to another embodiment of the inventive concept.

Referring to FIGS. 10 and 14, peripheral regions 322a to 322h except for the first to eighth terminals I1 to I8 of the outermost circular grating 321a of FIG. 10 may include a reflection structure. For example, the reflection structure may be a distributed bragg reflector (DBR). When optical signals having the wavelengths λ1 to λ8 that are demultiplexed for each wavelength are coupled as one vertical light source, the DBR may improve optical coupling efficiency. For another example, the DBR may be metal coating. Similarly, when the optical signals having the wavelengths λ1 to λ8 that are demultiplexed for each wavelength are coupled as one vertical light source, the metal coating may improve optical coupling efficiency.

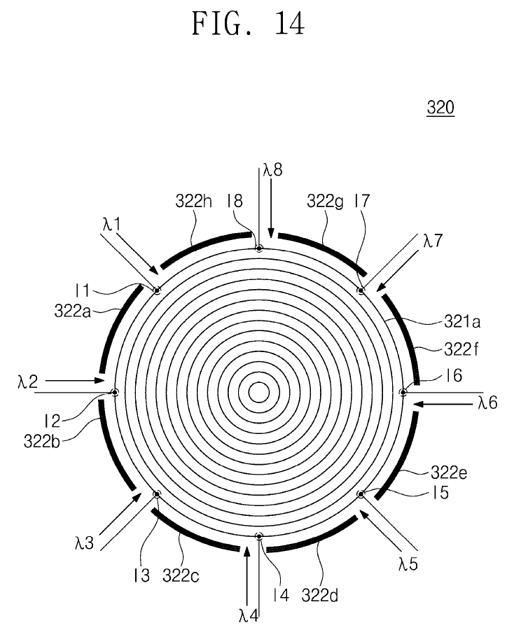

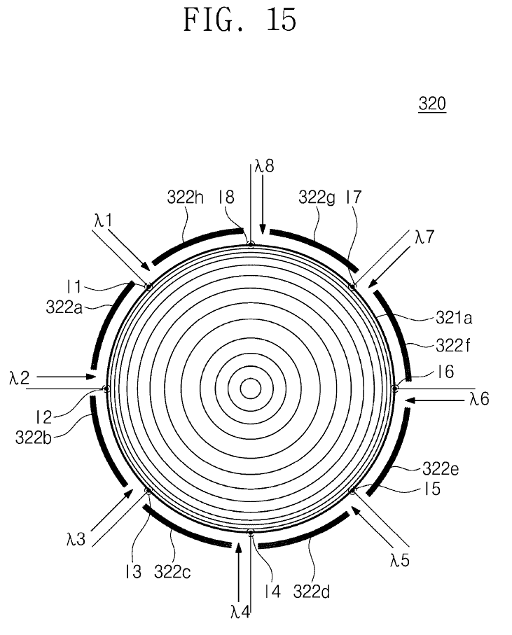

Referring to FIGS. 11 and 15, peripheral regions 322a to 322h except for the first to eighth terminals I1 to I8 of the outermost circular grating 321b of FIG. 11 may include a reflection structure. For example, the reflection structure may be a distributed bragg reflector. When optical signals having the wavelengths λ1 to λ8 that are demultiplexed for each wavelength are coupled as one vertical light source, the DBR may improve optical coupling efficiency. For another example, the reflection structure may be metal coating. Similarly, when the optical signals having the wavelengths λ1 to λ8 that are demultiplexed for each wavelength are coupled as one vertical light source, the metal coating may improve optical coupling efficiency.

Referring to FIGS. 12 and 16, peripheral regions 322a to 322h except for the first to fourth terminals I1 to I4 of the outermost circular gratings in the first to fourth regions R1 to R4 of FIG. 12 may include a reflection structure. For example, the reflection structure may be a distributed bragg reflector. When optical signals having the wavelengths λ1 to λ8 that are demultiplexed for each wavelength are coupled as one vertical light source, the DBR may improve optical coupling efficiency. For example, the reflection structure may be metal coating. Similarly, when the optical signals having the wavelengths λ1 to λ4 that are demultiplexed for each wavelength are coupled as one vertical light source, the metal coating may improve optical coupling efficiency.

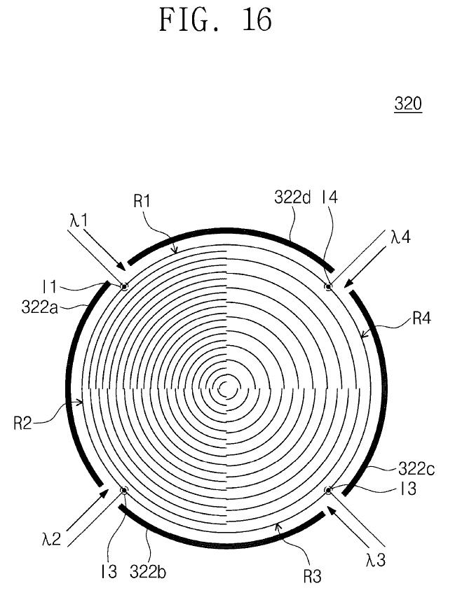

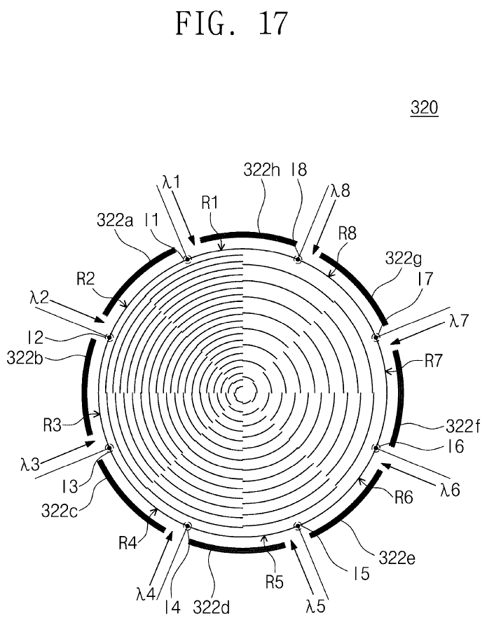

Referring to FIGS. 13 and 17, peripheral regions 322a to 322h except for the first to eighth terminals I1 to I8 of the outermost circular gratings in the first to eighth regions R1 to R8 may include a reflection structure.

For example, the reflection structure may be a distributed bragg reflector. The DBR may improve optical coupling efficiency in which the optical signals having the wavelengths λ1 to λ8 that are demultiplexed for each wavelength are coupled as one vertical light source. For example, the reflection structure may be metal coating. Similarly, the metal coating may improve optical coupling efficiency in which the optical signals having the wavelengths λ1 to λ8 that are demultiplexed for each wavelength are coupled as one vertical light source.

The output circular grating coupler 320 of the mux 300 is not limited to the structures of FIGS. 14 to 17. That is, it is understood that embodiments to which various changes are made without departing from the spirit and scope of the inventive concept are possible.

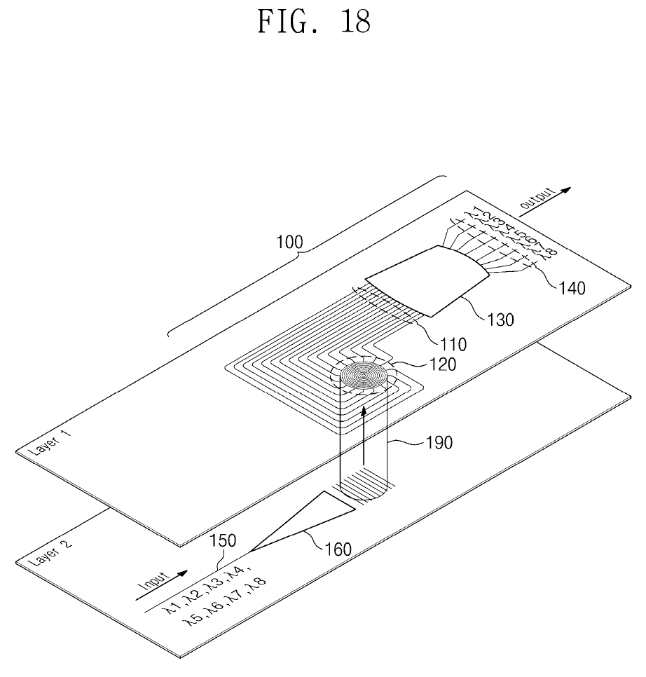

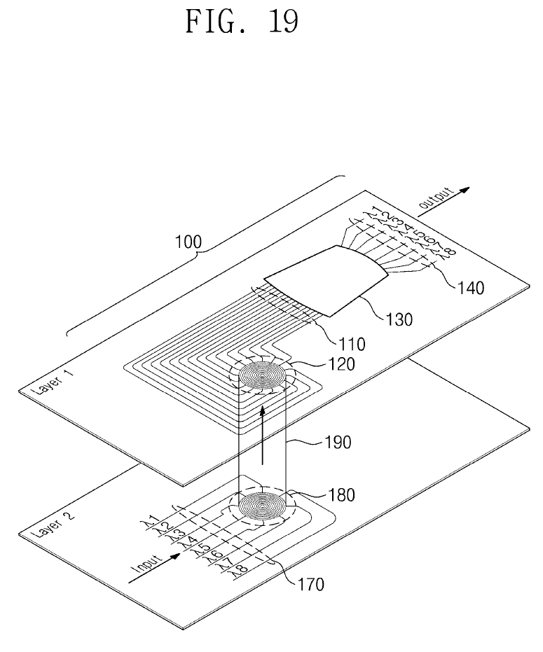

FIGS. 18 and 19 are views illustrating a case in which the wavelength division devices are vertically stacked according to an embodiment of the inventive concept.

Referring to FIGS. 2 to 18, the wavelength division device 100 according to an embodiment of the inventive concept may be disposed on a first layer Layer1.

The wavelength division device 100 disposed on the first layer Layer1 may include an input arrayed waveguide structure 110, an input circular grating coupler 120, an output star coupler 130, and output arrayed waveguides 140. The input circular grating coupler 120 of the wavelength division device 100 disposed on the first layer Layer1 may receive first multi-wavelength light having a plurality of wavelengths λ1 to λ8 from an optical fiber 180 that will be described later. Then, as illustrated in FIG. 2, the wavelength division device 100 may output optical signals having the wavelengths λ1 to λ8 that are demultiplexed for each wavelength. Since an operation of the wavelength division device 100 is the same as that described in FIG. 2, its duplicated description will be omitted.

The output waveguide 150 and the output circular grating coupler 160 may be disposed on a second layer Layer2.

The output waveguide 150 disposed on the second layer Layer2 may apply optical signals having a plurality of wavelengths to the output circular grating coupler 160. For example, the optical signals having the plurality of wavelengths may be signals having first to eighth wavelengths λ1 to λ8.

The output circular grating coupler 160 disposed on the second layer Layer2 may output the optical signals having the plurality of wavelengths as first multi-wavelength light having a plurality of wavelengths. For example, the first multi-wavelength light having the plurality of wavelengths may be signals having first to eighth wavelengths λ1 to λ8.

The optical waveguide 190 may connect the first layer Layer1 to the second layer Layer2. Also, the optical waveguide 190 may transmit the first multi-wavelength light outputted from the output circular grating coupler 160 disposed on the second layer Layer2 to the first layer Layer1. The optical waveguide 190 may be formed of a material having a refractive index greater than that of the surrounding material. If a distance between the layers is less, since spreading of light is less, the optical waveguide may be omitted. The first layer and the second layer may be fixed through wafer bonding or flip chip bonding.

Referring to FIGS. 2 to 19, the wavelength division device 100 according to an embodiment of the inventive concept may be disposed on a first layer Layer1. The wavelength division device 100 disposed on the first layer Layer1 may include an input arrayed waveguide structure 110, an input circular grating coupler 120, an output star coupler 130, and output arrayed waveguides 140. The input circular grating coupler 120 of the wavelength division device 100 disposed on the first layer Layer1 may receive first multi-wavelength light having a plurality of wavelengths that are transmitted from an optical waveguide 190 that will be described later. Then, the wavelength division device 100 of FIG. 2 may divide and output optical signals having the wavelengths that are demultiplexed for each wavelength. Since an operation of the wavelength division device 100 is the same as that described in FIG. 2, its duplicated description will be omitted.

The output arrayed waveguide structure 170 and the output circular grating coupler 180 may be disposed on a second layer Layer2.

The output arrayed waveguide structure 170 disposed on the second layer Layer2 may include a plurality of output waveguides. For example, the output arrayed waveguide structure 170 disposed on the second layer Layer2 may include first to eighth output waveguides. For example, the first to eighth optical signals λ1 to λ8 that are divided for each wavelength may be transmitted to the output circular grating coupler 180 through the first to eighth output waveguides.

The output circular grating coupler 180 disposed on the second layer Layer2 may multiplex the first to eighth optical signals λ1 to λ8 that are divided for each wavelength to output first multi-wavelength light having a plurality of wavelengths. For example, the first multi-wavelength light having the plurality of wavelengths may be optical signals having first to eighth wavelengths λ1 to λ8.

The optical waveguide 190 may connect the first layer Layer1 to the second layer Layer2. For example, the optical waveguide 190 may transmit the first multi-wavelength light outputted from the output circular grating coupler 160 disposed on the second layer Layer2 to the first layer Layer1.

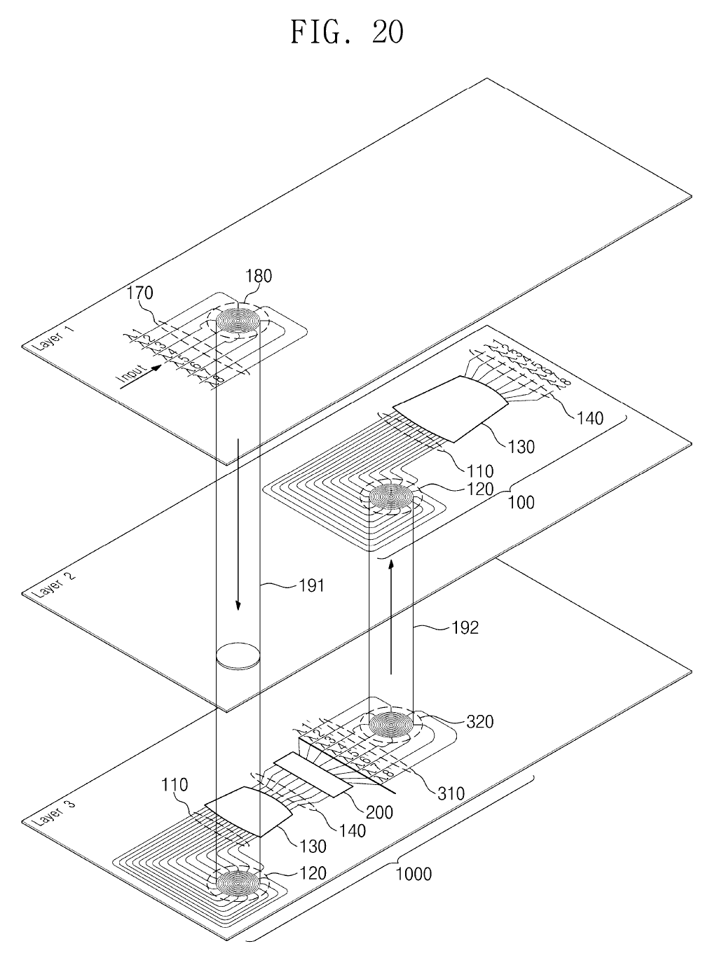

FIG. 20 is a view illustrating a case in which the wavelength division device and the wavelength division multiplexing system are vertically stacked according to an embodiment of the inventive concept.

Referring to FIG. 20, a first layer Layer1 may include an output arrayed waveguide structure 170 and an output circular grating coupler 180.

For example, the output arrayed waveguide structure 170 of the first layer Layer1 may include a plurality of output waveguides. For example, the first to eighth optical signals λ1 to λ8 that are divided for each wavelength may be transmitted to the output circular grating coupler 180 through the first to eighth output waveguides.

The output circular grating coupler 180 of the first layer Layer1 may multiplex the first to eighth optical signals λ1 to λ8 that are divided for each wavelength to output first multi-wavelength light having a plurality of wavelengths. For example, the first multi-wavelength light having the plurality of wavelengths may be optical signals having first to eighth wavelengths λ1 to λ8.

A first optical waveguide 191 may connect the first layer Layer1 to a third layer Layer3. For example, the first optical waveguide 191 may transmit the first multi-wavelength light outputted from the output circular grating coupler 180 of the first layer Layer1 to the third layer Layer3.

Referring to FIGS. 2 to 20, the wavelength division device 100 according to an embodiment of the inventive concept may be disposed on the second layer Layer2.

The wavelength division device 100 disposed on the second layer Layer2 may include an input arrayed waveguide structure 110, an input circular grating coupler 120, an output star coupler 130, and output arrayed waveguides 140. The wavelength division device 100 disposed on the second layer Layer2 may receive second multi-wavelength light having a plurality of wavelengths, which are transmitted from a second optical waveguide 192, to the input circular grating coupler 120. Then, as illustrated in FIG. 2, the wavelength division device 100 may output optical signals λ1 to λ8 that are divided for each wavelength. Since an operation of the wavelength division device 100 of FIG. 20 is the same as that described in FIG. 2, its duplicated description will be omitted.

Referring to FIGS. 9 to 20, the wavelength division multiplexing system 1000 according to an embodiment of the inventive concept may be disposed on the third layer Layer3.

The wavelength division multiplexing system 1000 disposed on the third layer Layer3 may receive first multi-wavelength light from the first optical waveguide 191 to optically process the first to eighth optical signals λ1 to λ8 that are divided for each wavelength. Then, the first to eighth optical signals λ1′ to λ8′ that are optically processed may be coupled to output the second multi-wavelength light through the second optical waveguide 192.

For another example, the wavelength division multiplexing system 1000 disposed on the third layer Layer3 may receive the first multi-wavelength light from the first optical waveguide 191 to output the first to eighth optical signals λ1 to λ8 that are divided for each wavelength. Then, the second multi-wavelength light in which the first to eighth optical signals λ1 to λ8 that are divided for each wavelength are coupled to each other may be outputted through the second light waveguide 192, or the second multi-wavelength light in which the first to eighth optical signals λ1 to λ8 that are optically processed may be outputted through the second optical waveguide 192.

The second optical waveguide 192 may connect the second layer Layer2 to the third layer Layer3. Also, the second optical waveguide 192 may transmit the second multi-wavelength light outputted from the wavelength division multiplexing system 1000 disposed on the third layer Layer3 to the second layer Layer2. Since an operation of the wavelength division device 1000 of FIG. 20 is the same as that described in FIG. 9, its duplicated description will be omitted.

As illustrated in FIGS. 18 to 20, a structure of the PIC may be more integrated through the vertically stacked structure.

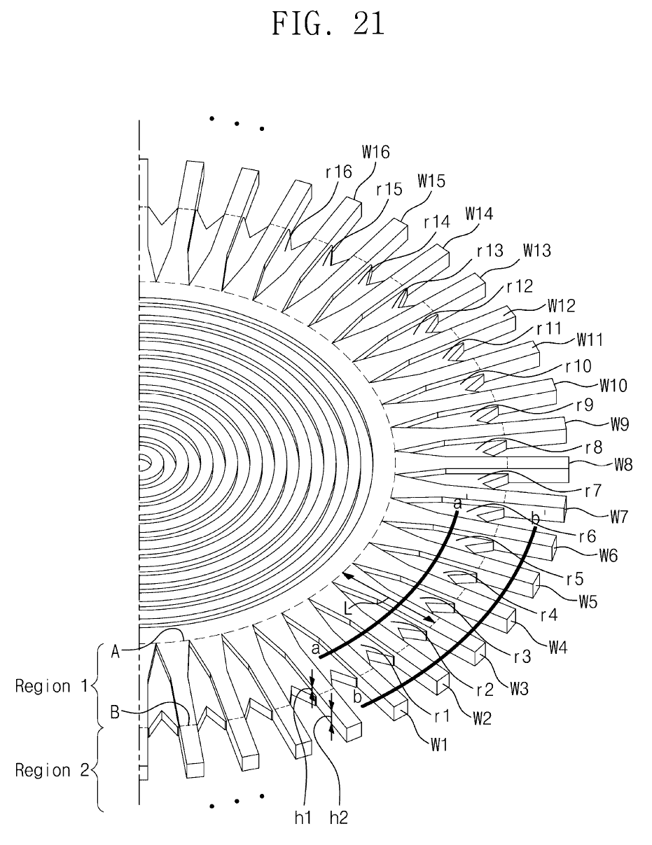

FIG. 21 is a side view illustrating an example (a linear taper structure) in which the input circular grating coupler is connected to one side of the input arrayed waveguide structure.

Referring to FIGS. 2 and 21, a plurality of waveguides W1 to W16 of the input arrayed waveguide structure 110 may be connected to the outermost circular grating (region A).

Also, second light having a uniform intensity may be outputted from the input circular grating coupler 120 in a direction that is perpendicular to a tangent of the outermost circular grating (region A). Here, the second light may travel along the plurality of waveguides W1 to W16 that are respectively coupled to a plurality of terminals I1 to I16. Also, the second light may be outputted to regions r1 to r15 between the plurality of waveguides W1 to W16.

For example, the first region r1 may represent a region between the first waveguide W1 and the second waveguide W2. Similarly, the fifteenth region r15 may represent a region between the fifteenth waveguide W15 and the sixteenth waveguide W16.

For example, each of the plurality of waveguides W1 to 16 and the first to fifteenth regions r1 to r15 may be formed of silicon (Si). Also, the plurality of waveguides W1 to W16 may be deposited, etched, or grown on silicon oxide (SiO₂).

Referring to FIG. 21, the second light that is outputted in the direction perpendicular to the tangent of the outermost circular grating (region A) may be coupled to each other in the regions (region B) of the plurality of waveguides W1 to W16 that are away from the outermost circular grating (region A) by a predetermined distance L.

The plurality of waveguides W1 to W16 of the input arrayed waveguide structure 110 may be etched, deposited, or grown in a first region Region1 to have a first depth h1. For example, the first region Region1 may represent regions (region B) of the plurality of waveguides W1 to W16 that are away from the outermost circular grating (region A) by a predetermined distance L. For example, the first depth h1 may represent a vertical distance from the uppermost portion of each of the plurality of waveguides W1 to W16 to the uppermost portion of each of the regions r1 to r16 between the plurality of waveguides W1 to W16.

When the second light travels to the regions (region B) of the plurality of waveguides W1 to W16 that are away from the outermost circular grating (region A) by the predetermined distance L, scattering of the second light in the regions r1 to r15 between the plurality of waveguides W1 to W16 may be reduced due to the above-described structure.

The plurality of waveguides W1 to W16 of the input arrayed waveguide structure 110 may be etched, deposited, or grown in a second region Region2 to have a second depth h2. For example, the second region Region2 may represent region after the regions (region B) of the plurality of waveguides W1 to W16. Also, the second depth h2 may be greater than the first depth h1. For example, the second depth h2 may represent a vertical distance from the uppermost portion of each of the regions r1 to r15 between the plurality of waveguides W1 to W16 to the lowermost portion of each of the regions r1 to r15.

Due to the above-described structure, coupling efficiency of the second light in the regions (region B) of the plurality of waveguides W1 to W16 may be improved.

Thus, in one example in which a portion of the input circular grating coupler 120 and one side of the input arrayed waveguide structure 110 are coupled to each other as illustrated in FIG. 21, a loss of the light that is diffracted in the circular grating coupler 120 to travel to the input arrayed waveguide structure 110 may be reduced.

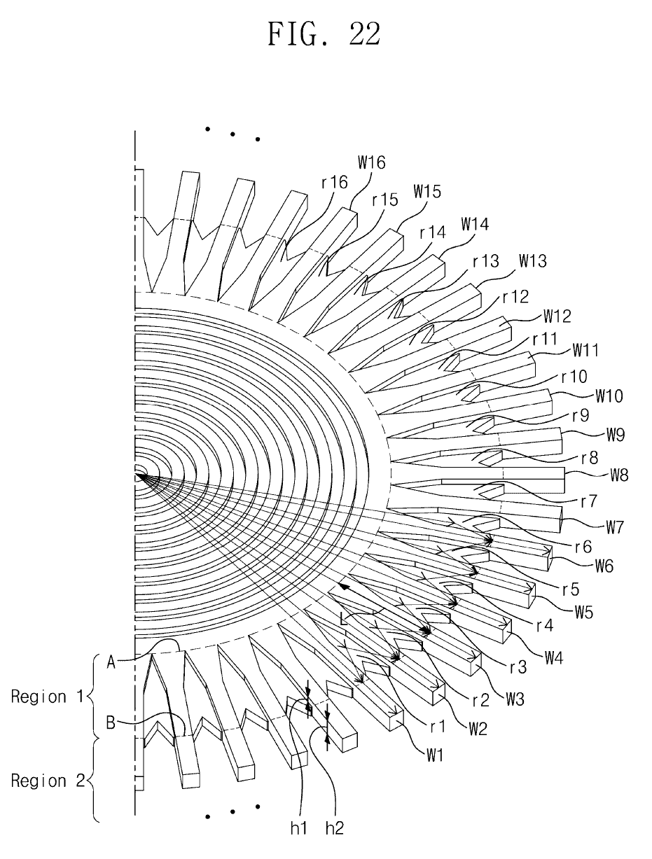

FIG. 22 is a view illustrating a state in which light is coupled in the side view illustrating the example in which the input circular grating coupler is connected to the one side of the input arrayed waveguide structure.

Referring to FIGS. 21 and 22, the second light having the uniform intensity may be outputted to the plurality of waveguides W1 to W16 and the regions r1 to r15 between the plurality of waveguides W1 to W16 by the input circular grating coupler 120. For example, in FIG. 22, it is assumed that the second light having the uniform intensity is outputted to the first to sixth waveguides W1 to W6 and the regions r1 to r5 between the first to sixth waveguides W1 to W6 by the input circular grating coupler 120.

Here, as illustrated in FIG. 2, the second light that is outputted in the direction perpendicular to the tangent of the outermost circular grating (region A) may be coupled to each other in the regions (region B) of the plurality of waveguides W1 to W6 that are away from the outermost circular grating (region A) by the predetermined distance L. Due to the above-described structure, when the second light travels to the regions (region B) of the first to sixth waveguides W1 to W6 that are away from the outermost circular grating (region A) by the predetermined distance L, scattering of the second light in the regions r1 to r5 between the first to sixth waveguides W1 to W6 may be reduced. Thus, a loss of the light traveling to the input arrayed waveguide structure 110 may be reduced.

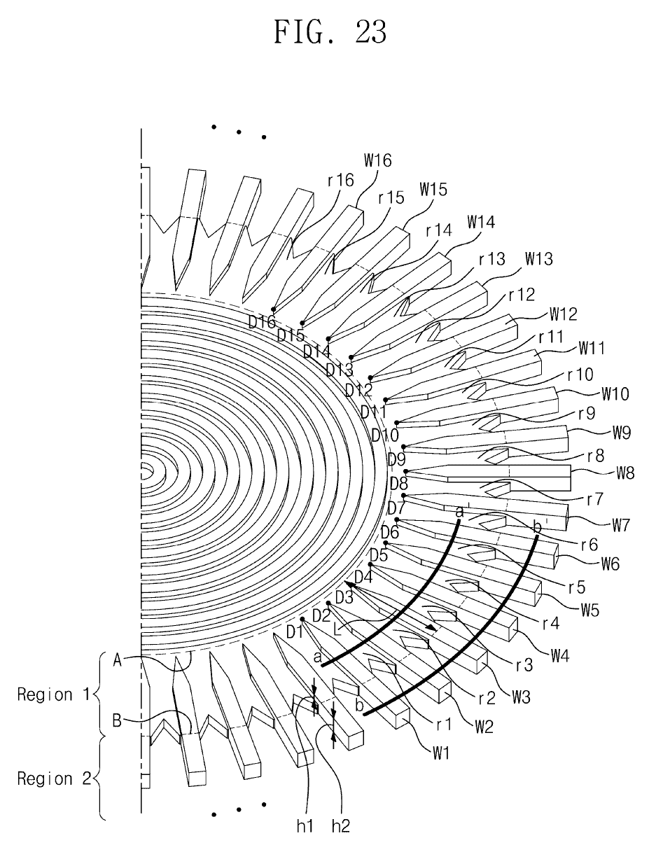

FIG. 23 is a side view illustrating another example (an inverse taper structure) in which the input circular grating coupler is connected to the one side of the input arrayed waveguide structure.

Referring to FIGS. 2 and 23, a plurality of waveguides W1 to W16 of the input arrayed waveguide structure 110 may be separated from the outermost circular grating (region A).

Also, second light having a uniform intensity may be outputted from the input circular grating coupler 120 in a direction that is perpendicular to a tangent of the outermost circular grating (region A). Here, the second light may travel along the plurality of waveguides W1 to W16 that are respectively coupled to a plurality of terminals I1 to I16. Also, the second light may be outputted to regions r1 to r15 between the plurality of waveguides W1 to W16.

For example, the first region r1 may represent a region between the first waveguide W1 and the second waveguide W2. Similarly, the fifteenth region r15 may represent a region between the fifteenth waveguide W15 and the sixteenth waveguide W16.

For example, each of the plurality of waveguides W1 to 16 and the first to fifteenth regions r1 to r15 may be formed of silicon (Si). On the other hand, the plurality of waveguides W1 to W16 may be deposited, etched, or grown on silicon oxide (SiO₂).

Referring to FIG. 23, the second light that is outputted in the direction perpendicular to the tangent of the outermost circular grating (region A) may be coupled to each other in the regions (region B) of the plurality of waveguides W1 to W16 that are away from the outermost circular grating (region A) by a predetermined distance L.

The plurality of waveguides W1 to W16 of the input arrayed waveguide structure 110 may be etched, deposited, or grown in a first region Region1 to have a first depth h1. For example, the first region Region1 may represent regions (region B) of the plurality of waveguides W1 to W16 that are away from the outermost circular grating (region A) by a predetermined distance L. For example, the first depth h1 may represent a vertical distance from the uppermost portion of each of the plurality of waveguides W1 to W16 to the uppermost portion of each of the regions r1 to r16 between the plurality of waveguides W1 to W16.

Due to the above-described structure, when the second light travels to the regions (region B) of the plurality of waveguides W1 to W16 that are away from the outermost circular grating (region A) by the predetermined distance L, scattering of the second light at ends D1 to D16 of the plurality of waveguides W1 to W16 may be reduced.

The plurality of waveguides W1 to W16 of the input arrayed waveguide structure 110 may be etched, deposited, or grown in the first region Region1 to have a second depth h2. For example, the second region Region2 may represent region after the regions (region B) of the plurality of waveguides W1 to W16. Also, the second depth h2 may be greater than the first depth h1. For example, the second depth h2 may represent a vertical distance from the uppermost portion of each of the regions r1 to r15 between the plurality of waveguides W1 to W16 to the lowermost portion of each of the regions r1 to r15.

Due to the above-described structure, coupling efficiency of the second light in the regions (region B) of the plurality of waveguides W1 to W16 may be improved.

Thus, in another example in which a portion of the input circular grating coupler 120 and one side of the input arrayed waveguide structure 110 are coupled to each other, a loss of the light that is diffracted in the circular grating coupler 120 to travel to the input arrayed waveguide structure 110 may be reduced.

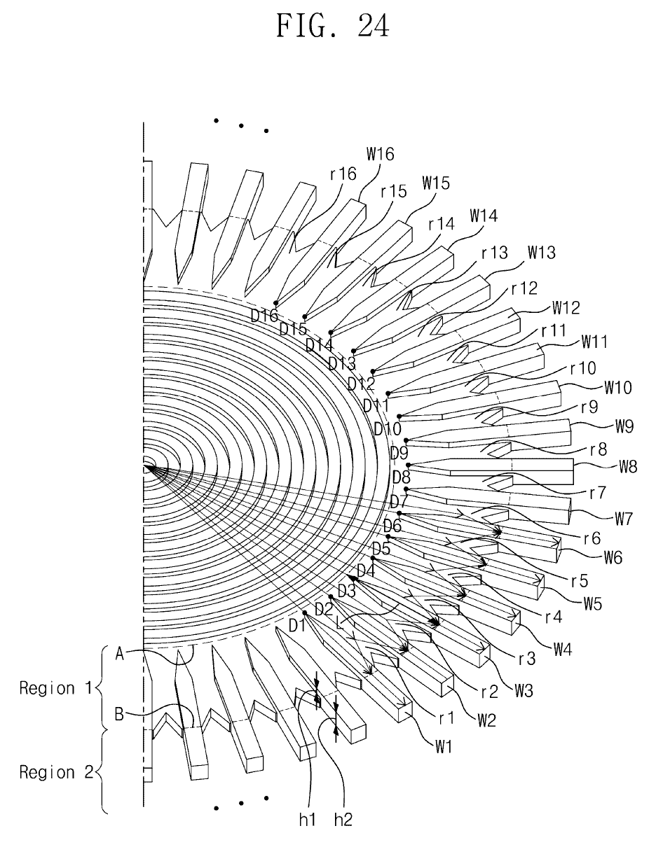

FIG. 24 is a view illustrating a state in which light is coupled in the side view illustrating another example in which the input circular grating coupler is connected to the one side of the input arrayed waveguide structure.

Referring to FIGS. 23 and 24, the second light having the uniform intensity may be outputted to the plurality of waveguides W1 to W16 and the regions r1 to r15 between the plurality of waveguides W1 to W16 by the input circular grating coupler 120. For example, in FIG. 24, it is assumed that the second light having the uniform intensity is outputted to the first to sixth waveguides W1 to W6 and the regions r1 to r5 between the first to sixth waveguides W1 to W6 by the input circular grating coupler 120.

Here, as illustrated in FIG. 24, the second light that is outputted in the direction perpendicular to the tangent of the outermost circular grating (region A) may be coupled to each other in the regions (region B) of the plurality of waveguides W1 to W6 that are away from the outermost circular grating (region A) by a predetermined distance L. Due to the above-described structure, when the second light travels to the regions (region B) of the first to sixth waveguides W1 to W6 that are away from the outermost circular grating (region A) by the predetermined distance L, scattering of the second light at ends D1 to D6 of the first to sixth waveguides W1 to W6 may be reduced. Thus, a loss of the light traveling to the input arrayed waveguide structure 110 may be reduced.

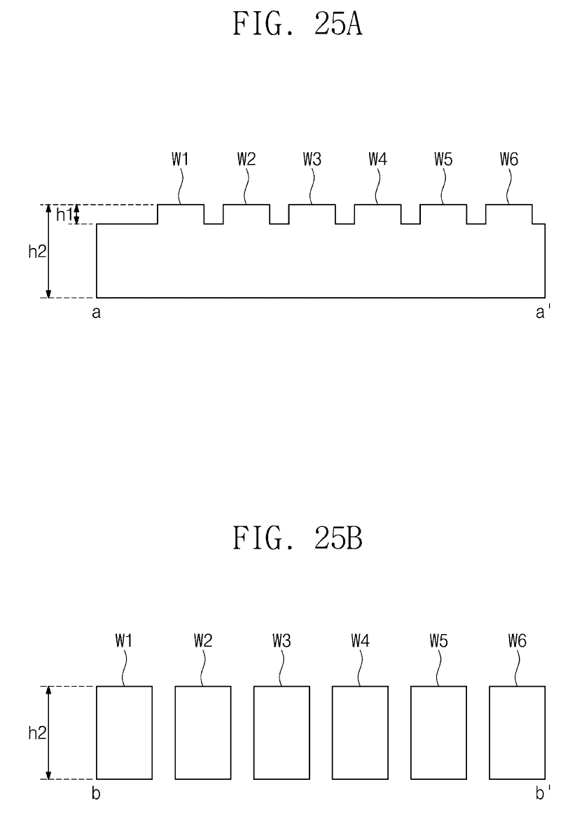

FIG. 25A is a cross-sectional view illustrating an example of the first region Region1 of the input array waveguide structure. Referring to FIGS. 2 and 21 to 25A, an exemplary cross-section a-a′ of the first to sixth waveguides W1 to W6 in the first region Region1 is illustrated. Particularly, a first depth h1 is defined in regions (region B) of the plurality of waveguides W1 to W16 that are away from the outermost circular grating (region A) by the predetermined distance L, and a second depth h2 is defined after regions (region B) of the plurality of waveguides W1 to W16.

FIG. 25B is a cross-sectional view illustrating an example of a second region Region2 of the input array waveguide structure.

Referring to FIGS. 2 and 21 to 25B, an exemplary cross-section b-b′ of the first to sixth waveguides W1 to W6 in the second region Region2 is illustrated. Particularly, a second depth h2 is defined after the regions (region B) of the plurality of waveguides W1 to W16.

FIG. 26 is a view of a wavelength multiplexing system having a layer structure according to an embodiment of the inventive concept. Referring to FIG. 26, a wavelength multiplexing system 400 may be integrated so that the wavelength multiplexing system 400 has a plurality of layers. For example, FIG. 26 illustrates the wavelength multiplexing system 400 including a layer structure 410 constituted by first to fourth layers 410a to 410d.

The first layer 410a of FIG. 26 includes a first wavelength division device. Also, the first wavelength division device includes a first input arrayed waveguide structure 411a, a first circular grating coupler 412a, a first star coupler 413a, and first output arrayed waveguides 414a. The second layer 410b of FIG. 26 includes a second wavelength division device. Also, the second wavelength division device includes a second input arrayed waveguide structure 411b, a second circular grating coupler 412b, a second star coupler 413b, and second output arrayed waveguides 414b.

The third layer 410c of FIG. 26 includes a third wavelength division device. Also, the third wavelength division device includes a third input arrayed waveguide structure 411c, a third circular grating coupler 412c, a third star coupler 413c, and third output arrayed waveguides 414c. The fourth layer 410d of FIG. 26 includes a fourth wavelength division device. Also, the fourth wavelength division device includes a fourth input arrayed waveguide structure 411d, a fourth circular grating coupler 412d, a fourth star coupler 413d, and fourth output arrayed waveguides 414d.

Also, the first to fourth circular grating couplers 412a, 412b, 412c, and 412d may be arrayed at the same position on an x-y plane. According to an embodiment of the inventive concept, when an optical loss that may occur when optical signals in a direction perpendicular to the circular grating couplers respectively disposed on the layers are coupled to each other may be minimized. However, the wavelength multiplexing system of FIG. 26 may be merely an example. That is, it is understood that more or less layers may be stacked when compared to the structure of FIG. 26.

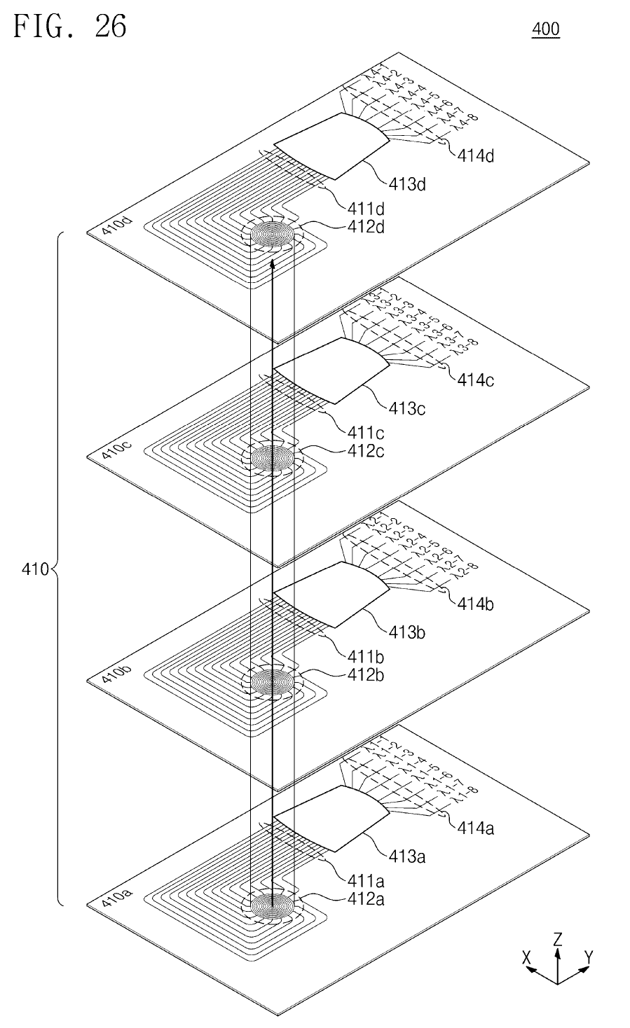

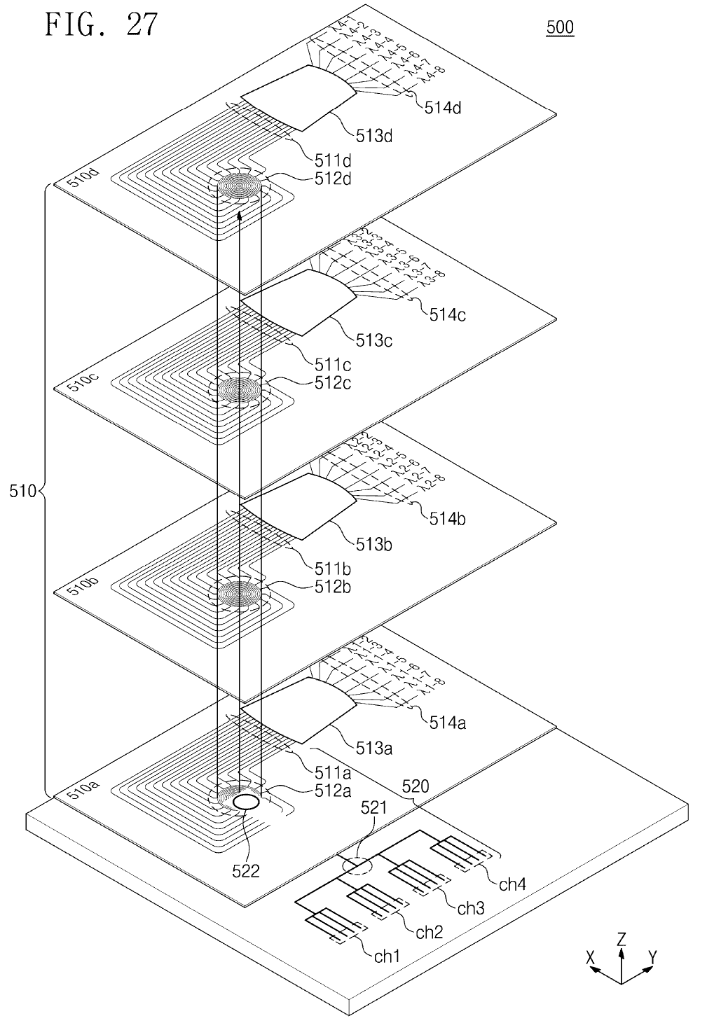

FIG. 27 is a detailed view of the wavelength multiplexing system having the layer structure of FIG. 26 according to an embodiment of the inventive concept. Referring to FIG. 27, a wavelength multiplexing system 500 may include a layer structure of first to fourth layers 510a to 510d and a channel input waveguide structure 520 having a plurality of channels.

The channel input waveguide structure 520 may include a plurality of channel waveguides ch1 to ch4, an optical coupling part 521, and a reflection part 522. The plurality of channel waveguides ch1 to ch4 may receive optical signals that are transmitted from an external device (not shown), an external chip (not shown), or a light source (not shown) within a chip. Since the rest components except for the channel input waveguide structure 520 of FIG. 27 are the same as those of FIG. 26, it is understood that their descriptions may be omitted.

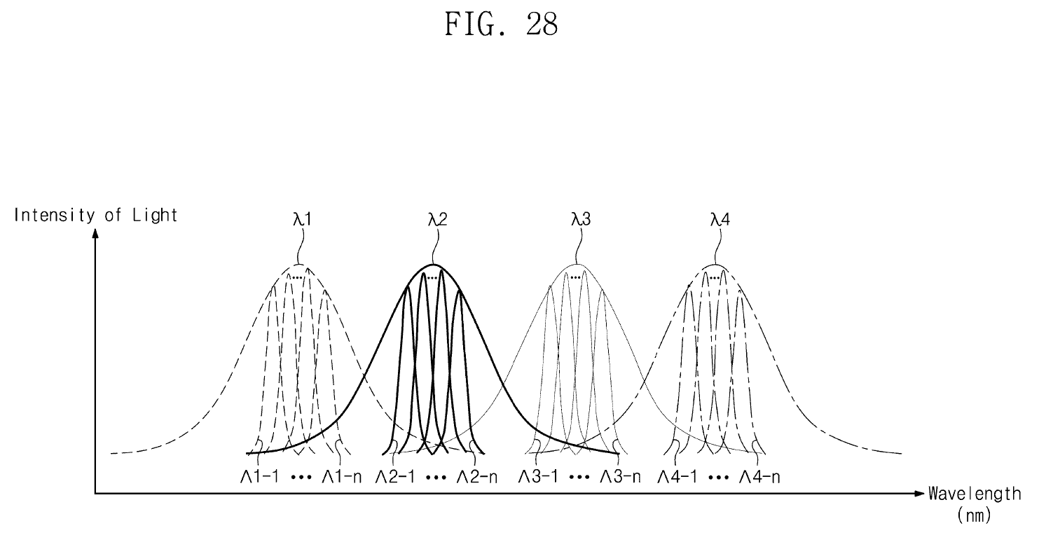

FIG. 28 is a view illustrating characteristics related to wavelength responsibility of a plurality of circular grating couplers. Referring to FIG. 28, a horizontal axis represents a wavelength (nm), and a vertical axis represents an intensity of light. Also, each of wavelength groups has a light intensity in the form of gaussian. A first wavelength group λ1 of FIG. 28 includes first wavelength band signals, i.e., wavelength groups λ1, . . . , and λ1-n and corresponds to the shortest wavelength band of the first to fourth wavelength groups λ1 to λ4. The second wavelength group λ2 includes a plurality of second wavelength band signals, i.e., wavelength groups λ2-1, . . . , and λ2-n and corresponds to the second-shortest wavelength band of the first to fourth wavelength groups λ1 to λ4.

The third wavelength group λ3 includes a plurality of third wavelength band signals, i.e., wavelength groups λ3-1, . . . , and λ3-n and corresponds to the third-shortest wavelength band of the first to fourth wavelength groups λ1 to λ4. The fourth wavelength group λ4 includes a plurality of fourth wavelength band signals, i.e., wavelength groups λ4-1, . . . , and λ4-n and corresponds to the longest wavelength band of the first to fourth wavelength groups λ1 to λ4.

Although the first to fourth wavelength groups are illustrated in FIG. 28, more or less wavelength groups may be provided. Also, the wavelength band signals belonging to each wavelength group may be distinguished (referred) according to peak points.

Referring to FIGS. 27 and 28, the first to fourth circular grating couplers 512a, 512b, 512c, and 512d of the first to fourth wavelength division devices respectivley arranged on the layers may be designed so that the first to fourth circular grating couplers 512a, 512b, 512c, and 512d have responsibility of wavelengths λ1 to λ4 different from each other. For example, when optical signals that are concentrated to the lowermost end of the first layer 510a and have a plurality of wavelength groups λ1 to λ4 are transmitted in a vertical direction (z direction), each of the first to fourth circular grating couplers 512a, 512b, 512c, and 512d may primarily and optically couple the optical signals having the plurality of wavelength groups λ1 to λ4 to each other to generate an optical signal having one optical wavelength group according to the wavelength responsibility of each of the first to fourth circular grating couplers 512a, 512b, 512c, and 512d.

Also, the optical signals having the one wavelength group, which are optically coupled to the circular grating couplers 512a, 512b, 512c, and 512d of each layer, may pass through a circular arrayed waveguide grating including input arrayed waveguide structures 511a, 511b, 511c, and 511d, stat couplers 513a, 513b, 513c, and 513d, and output arrayed waveguides 514a, 514b, 514c, and 514d, which are disposed on each layer. Finally, the plurality of optical signals corresponding to the wavelength bands belong to the one wavelength group may be outputted through the output arrayed waveguides 514a, 514b, 514c, and 514d in a second direction (y direction).

For example, it is assumed that an optical signal having the first wavelength group λ1 is inputted through a first channel ch1 in the first direction (x direction), an optical signal having the second wavelength group λ2 is inputted through a second channel ch2 in the first direction (x direction), an optical signal having the third wavelength group λ3 is inputted through a third channel ch3 in the first direction (x direction), and an optical signal having the fourth wavelength group λ4 is inputted through a fourth channel ch4 in the first direction (x direction).

Also, it is assumed that the wavelength responsibility of the first circular grating coupler 512a of the first layer 510a has a characteristic in which the first circular grating coupler 512a is optically coupled to an optical signal of the first wavelength group λ1, the wavelength responsibility of the second circular grating coupler 512b of the second layer 510b has a characteristic in which the second circular grating coupler 512b is optically coupled to an optical signal of the second wavelength group λ2, the wavelength responsibility of the third circular grating coupler 512c of the third layer 510c has a characteristic in which the third circular grating coupler 512c is optically coupled to an optical signal of the third wavelength group λ3, and the wavelength responsibility of the fourth circular grating coupler 512d of the fourth layer 510d has a characteristic in which the fourth circular grating coupler 512d is optically coupled to an optical signal of the fourth wavelength group λ4. Also, it is assumed that the optical signals having the plurality of wavelength groups λ1 to λ4 are transmitted through the reflection part 522 of FIG. 27 in the vertical direction (z direction).

The first circular grating coupler 512a of the first layer 510a may receive optical signals of the first to fourth wavelength groups λ1 to λ4 and be optically coupled to the optical signal of the first wavelength group λ1. The optical signals of the second to fourth wavelength groups λ2 to λ4 except for the signal of the first wavelength group λ1 may pass through the first circular grating coupler 512a to reach the second layer 510b. The optical signal of the first wavelength group λ1 may pass through the circular arrayed waveguide grating of the first layer 510a and be spectrumrized into wavelengths 1-1, . . . , and λ1-8.

The second circular grating coupler 512b of the second layer 510b may receive optical signals of the second to fourth wavelength groups λ2 to λA and be optically coupled to the optical signal of the second wavelength group λ2. The optical signals of the third and fourth wavelength groups λ3 and λ4 except for the signal of the second wavelength group λ2 may pass through the second circular grating coupler 512b to reach the third layer 510c. The optical signal of the second wavelength group λ2 may pass through the circular arrayed waveguide grating of the second layer 510b and be spectrumrized into wavelengths 2-1, . . . , and λ2-8.

The third circular grating coupler 512c of the third layer 510c may receive optical signals of the third and fourth wavelength groups λ3 and λ4 and be optically coupled to the optical signal of the third wavelength group λ3. The optical signal of the fourth wavelength group λ4 except for the signal of the third wavelength group λ3 may pass through the third circular grating coupler 512c to reach the fourth layer 510d. The optical signal of the third wavelength group λ3 may pass through the circular arrayed waveguide grating of the third layer 510c and be spectrumrized into wavelengths 3-1, . . . , and λ3-8.

The fourth circular grating coupler 512d of the fourth layer 510d may receive the optical signal of the fourth wavelength group λ4. Also, the fourth circular grating coupler 512d may be optically coupled to the received optical signal of the fourth wavelength group λ4. The optical signal of the fourth wavelength group λ4 may pass through the circular arrayed waveguide grating of the fourth layer 510d and be spectrumrized into wavelengths 4-1, . . . , and λ4-8.

The wavelength multiplexing system according to an embodiment of the inventive concept may distribute signals having various wavelengths to the layers by using the circular grating coupler that is designed to have the responsibility of the wavelengths different from each other. Also, the wavelength multiplexing system may detailedly multiplex the distributed optical signal again by using the circular arrayed waveguide grating that is manufactured on each of the layers. According to an embodiment of the inventive concept, due to the unified three-dimensional structure of the wavelength multiplexing system, the optical device may be improved in efficiency, and the optical loss occurring in the three-dimensional chip may be minimized.

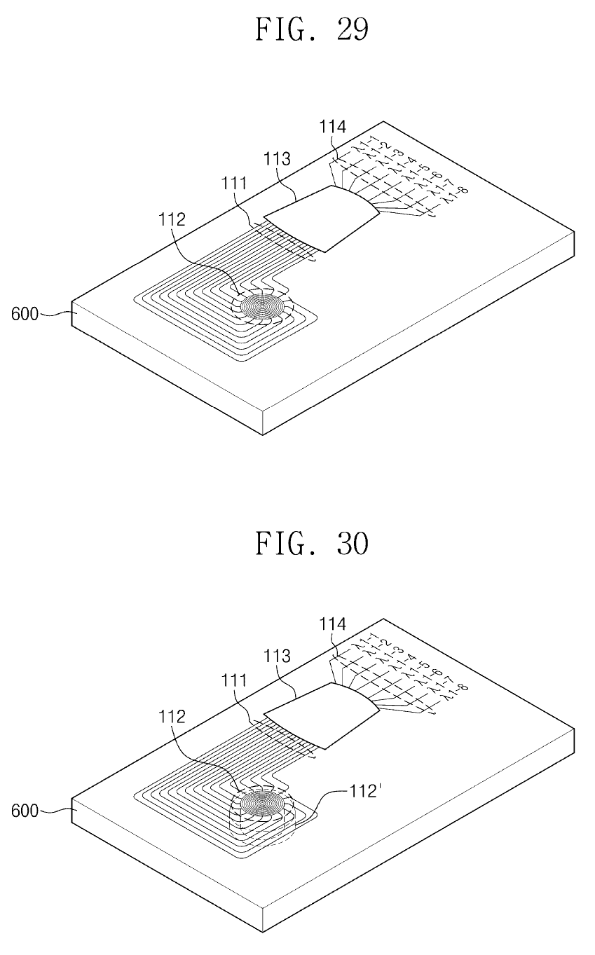

FIG. 29 is a view of a wavelength division device that is applicable to an embodiment of the inventive concept. Referring to FIG. 29, a wavelength division device according to an embodiment of the inventive concept may be disposed on a silicon-on-insulator (SOI) substrate 600. For brief description, it is assumed that the wavelength division device of FIGS. 29 to 32 is one of first to fourth wavelength division devices respectively disposed on the first to fourth layers 510a to 510d.

Referring to FIG. 29, the wavelength division device 410 of FIG. 29 may include an arrayed waveguide structure 411, a circular grating coupler 412, a star coupler 413, and output arrayed waveguide structures 414. Although not shown in FIG. 29, a clade (not shown) formed of silicon oxide (SiO₂) may be disposed on the SOI substrate 600.

The arrayed waveguide structure 411 of FIG. 29 may include a plurality of arrayed waveguides. The arrayed waveguide structure 411 may have one side connected to the circular grating coupler 412 and the other side connected to the star coupler 413.

Particularly, the arrayed waveguides of the arrayed waveguide structure 411 may extend in a direction perpendicular to a tangent of the outermost circular grating of the circular grating coupler 412.

The arrayed waveguides of the arrayed waveguide structure 411 of FIG. 29 may have a predetermined length difference therebetween. Also, the arrayed waveguides of the arrayed waveguide structure 411 may be disposed in parallel to each other. Also, the arrayed waveguide structure 411 may function as a diffraction grating.

The circular grating coupler 412 of FIG. 29 may be connected to one side of the arrayed waveguide structure 411, and the inside of the circular grating coupler 412 may include a plurality of circular gratings. For example, the circular grating coupler 412 may have the same center and have radii that gradually increase at a predetermined distance.

Thus, the circular grating coupler 412 may refract optical signals, which are optically coupled to the circular grating coupler 412, of second optical signals having a plurality of wavelength groups λ1 to λ4 to output a plurality of third optical signals having one wavelength group according to wavelength responsibility of the circular grating coupler 412. For example, the third optical signals may be diffracted to a plane that is perpendicular to an incident path of the second optical signals. Each of the plurality of third optical signals may be an optical signal having one wavelength group of the first to fourth wavelength groups λ1 to λ4 according to the wavelength responsibility of the circular grating coupler 412. For example, when the wavelength responsibility of the circular grating coupler 412 has a wavelength band of the first wavelength group λ1, the plurality of third optical signals may be optical signals having the first wavelength group λ1.

The star coupler 413 of FIG. 29 may receive the plurality of third light through the arrayed waveguide structure 411 and output low optical signals in which the plurality of received third light are demultiplexed for each wavelength to the output arrayed waveguide structures 414. For example, when the star coupler 413 has optical signals having the first wavelength group λ1, the star coupler 413 may output optical signals that are demultiplexed for each of low wavelengths λ1-1 to λ1-8 through the output arrayed waveguide structures 414.

The output arrayed waveguide structures 414 of FIG. 29 may be connected to the other side of the star coupler 413. Also, each of the output arrayed waveguide structures 414 may output the optical signals that are demultiplexed for each of low wavelengths λ1-1 to λ1-8 from the star coupler 413 to an external device (not shown).

The plurality of arrayed waveguides of the arrayed waveguide structure 411, the plurality of circular gratings of the circular grating coupler 412, and the output arrayed waveguides of the output arrayed waveguide structures 414 are not limited to the structures illustrated in FIG. 29. Also, the above-described characteristics may be applied to the wavelength division devices that are arranged on different layers (e.g., second to fourth layers) having a stack structure. That is, it is understood that embodiments to which various changes are made without departing from the spirit and scope of the inventive concept are possible.

FIG. 30 is a view of a wave division device that is applicable to an embodiment of the inventive concept. Referring to FIGS. 29 and 30, a circular grating coupler 412 of FIG. 30 has a cylindrical structure 412′ that is etched in a direction perpendicular to the SOI substrate 600, unlike the circular grating coupler 412 of FIG. 29. In case of the structure of the circular grating coupler 412 of FIG. 30, optical signals having a plurality of wavelength groups λ1 to λ4 and traveling in the direction perpendicular to the SOI substrate 600 may be prevented from being spread. Thus, an overall optical loss of the wavelength division system may be reduced.

Although not shown in FIG. 30, a clade (not shown) formed of silicon oxide (SiO₂) may be disposed on the SOI substrate 600. Since the rest components except for the circular grating coupler 412 of components of FIG. 30 are the same as those of the above-described circular grating coupler, it is understood that their descriptions may be omitted.

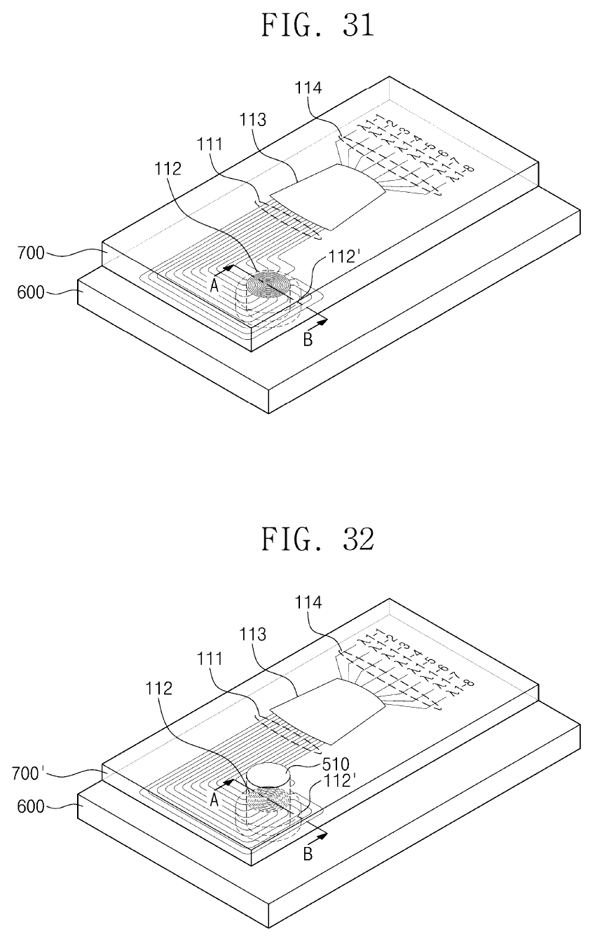

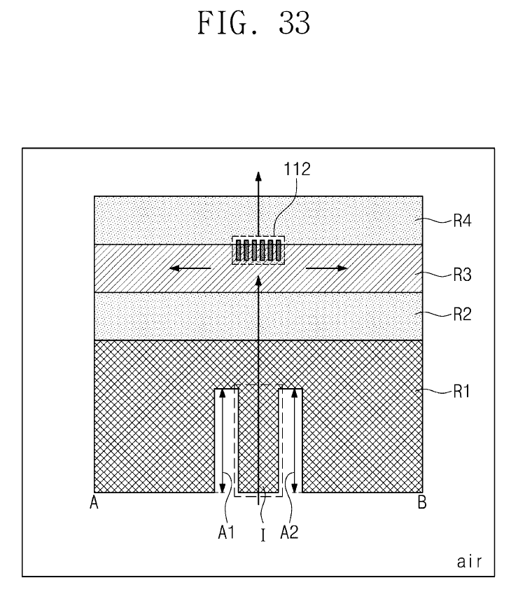

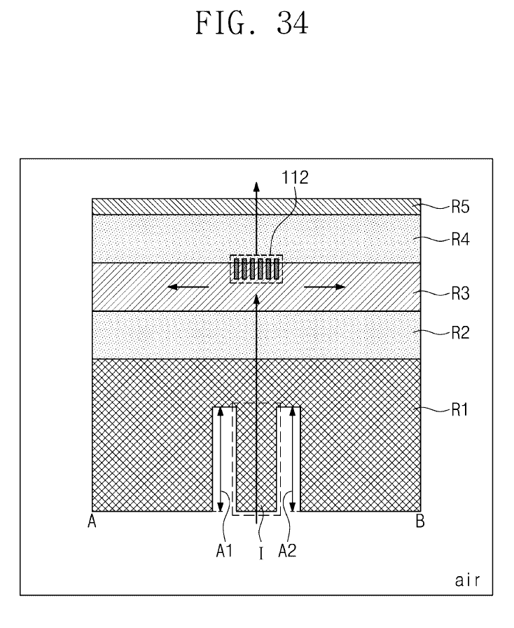

FIG. 31 is a detailed view illustrating a structure of the wavelength division device of FIG. 20 according to an embodiment of the inventive concept. A wavelength division device of FIG. 31 is disposed on an SOI substrate 600. Also, a clade layer 700 formed of silicon oxide (SiO₂) may be disposed on the wavelength division device. A cross-section A-B of FIG. 31 will be described in more detail with reference to FIGS. 33 and 34.

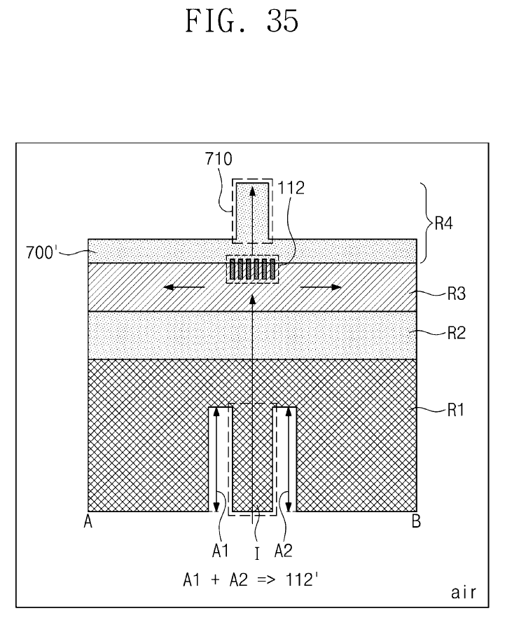

FIG. 32 is a detailed view illustrating a structure of the wavelength division device of FIG. 31 according to an embodiment of the inventive concept. A wavelength division device of FIG. 32 may have a structure that further includes a clade having a cylindrical structure 710 on a circular grating coupler 412 by etching a portion of a clade layer 700′. A cross-section A-B of FIG. 32 will be described in more detail with reference to FIG. 35.

FIG. 33 is a cross-sectional view of the wavelength division device of FIG. 31 according to an embodiment of the inventive concept. Referring to FIGS. 31 and 33, the cross-section A-B of FIG. 31 has first to fourth regions R1 to R4. The first region R1 may correspond to the SOI substrate 600, and air gaps A1 and A2 may be provided in both sides of an input waveguide I into which optical signals having a plurality of wavelength groups are incident. Since the air layers are provided in both sides of the input waveguide I, the input waveguide I may have a cylindrical structure.

Silicon (Si) of the SOI substrate 600 may have a refractive index greater than that of air. Optical signals may be concentrated to a side having a relatively high refractive index. Thus, an optical loss of the optical signal traveling along the input waveguide I having the structure as illustrated in FIG. 33 may be reduced. The second region R2 may be defined above the first region R1 and formed based on silicon oxide (SiO₂). The second region R2 may have a refractive index less than that of the first region R1.

The third region R3 may be defined above the second region R2 and formed based on silicon (Si). Also, the circular grating coupler 412 is formed by etching the silicon (Si) of the third region R3. In this case, the optical signals of the plurality of wavelength groups may reach the third region R3 via the first and second regions R1 and R2. The optical signals having the plurality of wavelength groups may be optically coupled according to wavelength responsibility of the circular grating coupler disposed in the third region R3. In this case, the optical signals that are optically coupled to the circular grating coupler 412 may travel along the third region R3. Also, optical signals that are not optically coupled to the circular grating coupler 412 may travel along the fourth region R4.

For example, when the circular grating coupler 412 disposed in the third region R3 has a characteristic in which the circular grating coupler 412 is optically coupled to the optical signals having the first wavelength group λ1, optical signals having the first wavelength group λ1 of the optical signals having the plurality of wavelength groups λ1 to λ4 may be optically coupled to the circular grating coupler 412 of the third region R3. Thus, the optical signals having the first wavelength group λ1 may horizontally travel through the third region R3. Then, optical signals having wavelengths of the second to fourth wavelength groups λ2 to λ4 except for the first wavelength group λ1 may travel to the fourth region R4.

The fourth region R4 is formed based on silicon oxide (SiO₂) and receives the optical signals having the second to fourth wavelength groups λ2 to λ4. The fourth region R4 may have a refractive index less than that of the third region R3. The optical signals passing through the fourth region R4 may travel to an upper layer within the layer structure.

FIG. 34 is a cross-sectional view of the wavelength division device of FIG. 31 according to another embodiment of the inventive concept. Referring to FIGS. 31 and 34, a cross-section A-B of FIG. 34 has first to fifth regions R1 to R5. In this case, the first to fourth regions R1 to R4 have the same as those of FIG. 33. Thus, detailed descriptions with respect to the first to fourth regions R1 to R4 will be omitted.

The fifth region R5 of FIG. 34 is formed as anti-reflection (AR) coating that corresponds to a wavelength band passing through the circular grating coupler 412 of third region R3. In this case, the AR coating may be designed so that the AR coating reflects the optical signals having the wavelength band corresponding to the wavelength responsibility of the circular grating coupler 412 of the third region R3 again to the third region R3 and allow the optical signals having the rest wavelength bands to pass through the next layer. Thus, when the wavelength division device having the structure of FIG. 34 is used, the overall optical efficiency of the wavelength multiplexing system may be improved.

FIG. 35 is a cross-sectional view of the wavelength division device of FIG. 32 according to an embodiment of the inventive concept. Referring to FIGS. 32 and 35, a cross-section A-B of FIG. 35 has first to fourth regions R1 to R4. In this case, the first to third regions R1 to R3 have the same as those of FIG. 33. Thus, detailed descriptions with respect to the first to third regions R1 to R3 will be omitted.

The fourth region R4 of FIG. 35 may correspond to a clade formed based on silicon oxide (SiO₂). However, unlike FIG. 33, the fourth region R4 of FIG. 35 may include a cylindrical structure 710 by partially etching the clade layer stacked on the circular grating coupler 412 disposed in the third region R3. Also, the fourth region R4 of FIG. 35 may include a clade layer 700′ having a thinner than the fourth region R4. Since the structure of FIG. 35 is provided, the optical signals traveling in the vertical direction via the fourth region R4 may be prevented from being spread. Thus, the overall optical efficiency of the wavelength multiplexing system may be more improved.

Also, although not shown in FIG. 35, an anti-reflection (AR) coating having a wavelength band and passing through the circular grating coupler 412 of the third region R3 may be disposed on an upper end of a cylindrical structure 710.

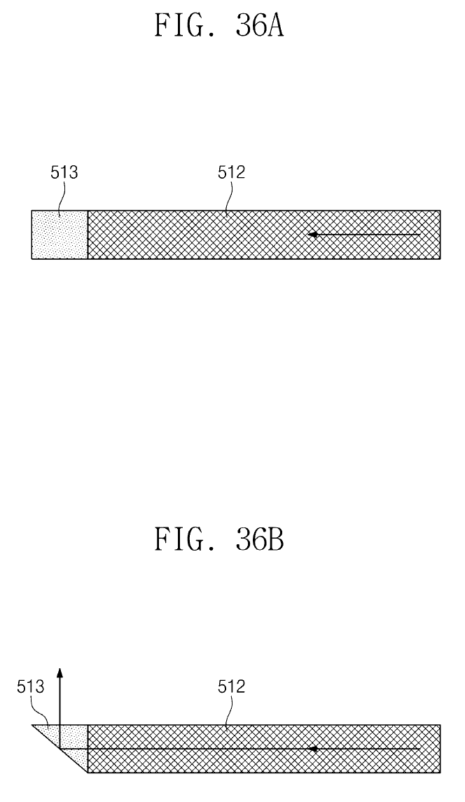

FIGS. 36A and 36B are views illustrating a structure of a reflection part of an input waveguide structure of the wavelength division system according to an embodiment of the inventive concept. FIG. 36A is a top view of an input waveguide 512 and a reflection part 513 of an input arrayed waveguide structure 510. Optical signals having a plurality of wavelength groups travel to the reflection part 513 through the input waveguide 512. Then, the optical signals reaching the reflection part 513 is reflected in a direction perpendicular to the ground to travel.

FIG. 36B is a side view of the input waveguide 512 and the reflection part 513 of an input arrayed waveguide structure 510. Optical signals having a plurality of wavelength groups travel to the reflection part 513 through the input waveguide 512. Also, the reflection part 513 has a reflection surface that is inclined at a predetermined angle. For example, to improve reflexibility, the reflection surface of the reflection part 513 may have a structure that is inclined at an angle of about 45 degrees and include metal coating.

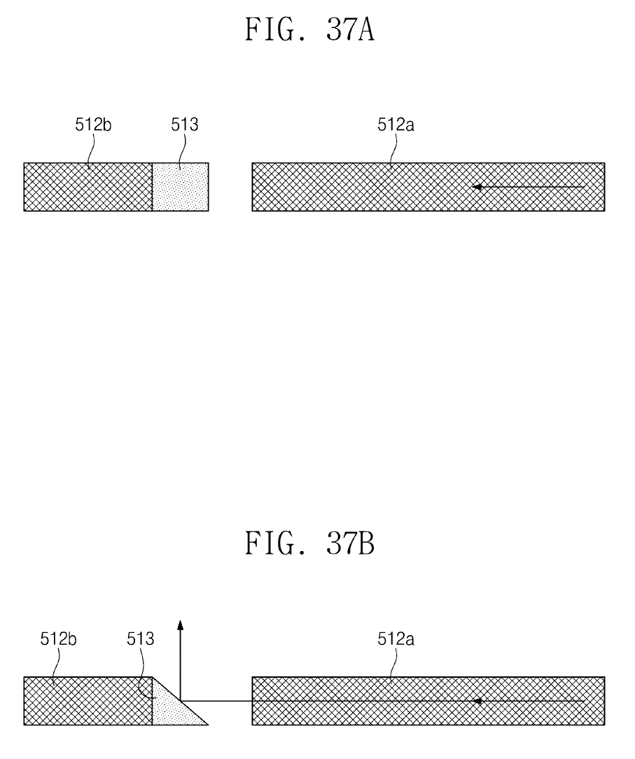

FIGS. 37A and 37B are views illustrating a structure of a reflection part of an input waveguide structure of the wavelength division system according to another embodiment of the inventive concept. FIG. 36A is a top view of a first input waveguide 512a, a second input waveguide 512b, and a reflection part 513 of an input arrayed waveguide structure 510. Optical signals having a plurality of wavelength groups reach the reflection part 513 after passing through a clade region via the first input waveguide 512a. The optical signals reaching the reflection part 513 is reflected in a direction perpendicular to the ground to travel. Also, the second input waveguide 512n is disposed on a rear surface of the reflection part 513.

FIG. 37B is a side view of the first input waveguide 512a, the second input waveguide 512b, and the reflection part 513 of the input arrayed waveguide structure 510. Optical signals having a plurality of wavelength groups pass through a clade region via the first input waveguide 512a. Also, the optical signals having the plurality of wavelength groups reach the reflection part 513. The reflection part 513 may include a reflection surface that is inclined at a predetermined angle. For example, to improve reflexibility of the reflection part 513, the reflection surface of the reflection part 513 may have a structure that is inclined at an angle of about 45 degrees and include metal coating. Furthermore, to improve the reflexibility of the reflection part 513, the second input waveguide 512b may be disposed on a rear surface of the reflection part 513.

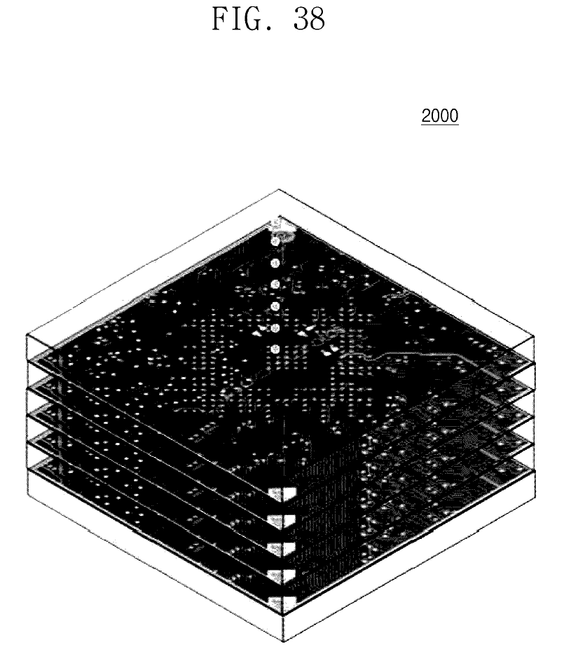

FIG. 38 is a view illustrating one of application examples of the inventive concept. The wavelength division system 2000 according to an embodiment of the inventive concept may be a three-dimensional PIC chip including a plurality of layers. According to the application example of the inventive concept, the chip that is miniaturized and reduced in cost and has various functions may be integrated as one structure.

According to the embodiments of the inventive concept, the wavelength division device that is advantageous for the high integration and has the improved reliability and the wavelength division multiplexing system may be provided.

Also, according to the embodiments of the inventive concept, the wavelength multiplexing system in which the structure that distributes the optical signal having the plurality of wavelengths into each of the layers is unified to improve the operation efficiency of the optical device and that is capable to the 3-D chip structure that is capable of minimizing the optical loss that may occur in the process of distributing the optical signal having the plurality of wavelengths into each of the layers may be provided.

While this disclosure has been particularly shown and described with reference to preferred embodiments thereof, it will be understood by those skilled in the art that various changes in form and details may be made therein without departing from the spirit and scope of the inventive concept as defined by the appended claims. Therefore, the scope of the disclosure is defined not by the detailed description of the inventive concept but by the appended claims, and all differences within the scope will be construed as being included in the inventive concept.

What is claimed is:

1. A wavelength division device comprising:
input arrayed waveguides;
an input circular grating coupler connected to one ends of the input arrayed waveguides and configured to refract first light having a plurality of wavelengths and output the refracted first light to each of the one ends of the input arrayed waveguides as plurality of second light; and
an output star coupler connected to other ends of the input arrayed waveguides and configured to receive the plurality of second light from the other ends of the input arrayed waveguides and output optical signals that are divided for each wavelength,
wherein the input circular grating coupler comprises a plurality of circular gratings.

2. The wavelength division device of claim 1, wherein the input circular grating coupler refracts the first light to a plane perpendicular to an incident path to output the plurality of second light.

3. The wavelength division device of claim 1, wherein each of the plurality of second light has an intensity in which an intensity of the first light is equally distributed.

4. The wavelength division device of claim 1, wherein the plurality of circular gratings have the same center and radii that gradually increase at a predetermined distance.

5. The wavelength division device of claim 1, wherein the outermost circular grating of the plurality of circular gratings comprises at least two terminals.

6. The wavelength division device of claim 5, wherein the at least two terminals of the outermost circular grating are connected to the one ends of the input arrayed waveguides.

7. The wavelength division device of claim 6, further comprising a waveguide material disposed from the outermost circular grating to a first region in each of regions between the input arrayed waveguides.

8. The wavelength division device of claim 7, wherein the uppermost portion of the waveguide material is disposed lower than the uppermost portion of each of the input arrayed waveguides.

9. The wavelength division device of claim 1, wherein the output star coupler outputs the optical signals that are divided for each wavelength by using an optical path difference between the plurality of second light.

10. A wavelength division multiplexing system comprising:
a wavelength division device to receive first multi-wavelength light having a plurality of wavelengths and output optical signals that are divided for each wavelength;
a photonic component to receive the optical signals that are divided for each wavelength and output optically processed optical signals; and
a wavelength coupling device to receive the optically processed optical signals and output second multi-wavelength light having a plurality of wavelengths,
wherein the wavelength division device comprises:
input arrayed waveguides;
an input circular grating coupler connected to one ends of the input arrayed waveguides and configured to refract first light having a plurality of wavelengths and output the refracted first light to each of the one ends of the input arrayed waveguides as plurality of second light; and
an output star coupler connected to the other ends of the input arrayed waveguides and configured to receive the plurality of second light from the other ends of the input arrayed waveguides and output optical signals that are divided for each wavelength,
wherein the input circular grating coupler comprises a plurality of circular gratings.

11. The wavelength division multiplexing system of claim 10, wherein the wavelength coupling device comprises:
output arrayed waveguides; and
an output circular grating coupler coupled to the optically processed optical signals to output the second multi-wavelength light having the plurality of wavelengths,
wherein the output circular grating coupler comprises a plurality of second circular gratings.

12. The wavelength division multiplexing system of claim 11, wherein the plurality of second circular gratings have the same center and radii that gradually increase at a predetermined distance.

13. The wavelength division multiplexing system of claim 11, wherein the plurality of second circular gratings have the same center and radii that gradually increase at a gradually decreasing distance.

14. The wavelength division multiplexing system of claim 11, wherein the outermost circular grating of the plurality of second circular gratings comprises as many terminals as the number of optical signals that are divided for each wavelength, and the optically processed optical signals are respectively received to the terminals.

15. The wavelength division multiplexing system of claim 14, wherein the output circular grating coupler is coupled to the optically processed optical signals received through the terminals connected to the outermost circular grating to output the second multi-wavelength light.

16. The wavelength division multiplexing system of claim 14, wherein the output circular grating coupler further comprises a distributed bragg reflector provided in a peripheral region except for the terminals of the outermost circular grating.

17. The wavelength division multiplexing system of claim 11, wherein the output circular grating coupler has a circular shape, and spaces within the circular shape are divided into regions corresponding to the optical signals that are divided for each wavelength with respect to the same center, and
each of the regions comprises gratings having arc shapes with radii that gradually increase with respect to the center.

18. The wavelength division multiplexing system of claim 10, wherein the wavelength division device, the photonic component, and the wavelength coupling device are disposed on the same plane, and
at least one of the first multi-wavelength light or the second multi-wavelength light is received from or outputted to the other plane that is parallel to the same plane.

19. A wavelength multiplexing system comprising:
an input waveguide structure comprising a plurality of optical channels and configured to optically couple first optical signals received from the plurality of optical channels to each other, thereby outputting a second optical signal; and
a three-dimensionally stacked layer structure configured to receive the second optical signal,
wherein the layer structure comprises a plurality of layers, and each of the plurality of layers comprises a wavelength division device, and
the wavelength division device comprises an input circular grating coupler having wavelength responsibility according to each of the plurality of layers and refracts an optical signal, which is optically and selectively coupled to the circular grating coupler according to the wavelength responsibility, of the second optical signal to output a plurality of third optical signals.

20. The wavelength multiplexing system of claim 19, wherein the wavelength division device further comprises:
input arrayed waveguides connected to the input circular grating coupler; and
an output star coupler configured to receive the third optical signals from the input arrayed waveguides and output fourth optical signals according to an optical path difference between the received third optical signals.
